(19) United States
(12) Patent Application Publication
(10) Pub. No.: US 2019/0233102 A1
(43) Pub. Date: Aug. 1, 2019

(54) DRONE MANAGEMENT SYSTEM AND DRONE MANAGEMENT METHOD

(71) Applicant: Toyota Jidosha Kabushiki Kaisha, Toyota-shi Aichi-ken (JP)

(72) Inventors: Daiki Kaneichi, Nisshin-shi Aichi-ken (JP); Yusuke Kaneko, Nagoya-shi Aichi-ken (JP); Masato Endo, Nagakute-shi Aichi-ken (JP); Shinji Sassa, Ama-shi Aichi-ken (JP); Takahiro Shiga, Chiryu-shi Aichi-ken (JP); Yohei Tanigawa, Toyota-shi Aichi-ken (JP)

(73) Assignee: Toyota Jidosha Kabushiki Kaisha, Toyota-shi Aichi-ken (JP)

(21) Appl. No.: 16/257,737

(22) Filed: Jan. 25, 2019

(30) Foreign Application Priority Data
Jan. 30, 2018 (JP) 2018-013948

(51) Int. Cl. B64C 39/02; G08G 5/00; G06Q 10/08

(52) U.S. Cl. CPC B64C 39/024; G08G 5/0069; B64C 2201/146; B64C 2201/126; G06Q 10/083

(57) ABSTRACT

Disclosed is a drone management system including a plurality of drones configured to fly, a plurality of vehicles each provided with a landing field where at least one of the drones is able to take off and land, a reception unit configured to receive a request for a service using a drone, an acquisition unit configured to acquire positional relationships between the drones and the vehicles, and a controller configured to select a first drone that flies to a destination of the service from among the drones and select a first vehicle as a landing destination of the first drone from among, the vehicles based on the positional relationships between the drones and the vehicles.

### CROSS-REFERENCE TO RELATED APPLICATIONS

This application claims priority to Japanese Patent Application No. 2018-013948 filed on Jan. 30, 2018, which is incorporated herein by reference in its entirety including the specification, drawings and abstract.

### BACKGROUND

### 1. Technical Field

The present disclosure relates to a drone management system that delivers a drone to a destination and a drone management method.

### 2. Description of Related Art

A delivery system of a package using a drone has been disclosed (for example, Japanese Unexamined Patent Application Publication No. 2016-153337 (JP 2016-153337 A)). In the delivery system of a package using a drone, for example, a delivery vehicle mounted with a drone moves to a predetermined area along with the drone, and the drone flies to a house that is a destination for home delivery in the predetermined area and delivers the package. When home delivery with the drone is finished, the drone returns to the delivery vehicle, and the delivery vehicle moves to a different area along with the drone.

### SUMMARY

However; since the number of delivery vehicles where the drone takes off and lands is limited to one, efficiency of delivery with the drone may not be improved. The problem is not limited to delivery of the package with the drone and may occur in, for example, a service that lends the drone itself, or the like.

The disclosure provides a technique for improving efficiency of delivery of a drone in a system that delivers the drone to a destination.

A first aspect of the disclosure relates to a drone management system. The drone management system includes a plurality of drones, a plurality of vehicles, a reception unit, an acquisition unit, and a controller. The drones are configured to fly. Each of the vehicles is provided with a landing field where at least one of the drones is able to take off and land. The reception unit is configured to receive a request for a service using a drone. The acquisition unit is configured to acquire positional relationships between the drones and the vehicles. The controller is configured to select a first drone that flies to a destination of the service from among the drones and select a first vehicle as a landing destination of the first drone from among the vehicles based on the positional relationships between the drones and the vehicles. The first vehicle and the first drone are configured to provide the service based on the selection.

The positional relationships between the drones and the vehicles are information indicating a drone that lands on a landing field and a vehicle that has the landing field where the drone lands, positional information of each drone and each, vehicle, and the like. According to the first aspect of the disclosure, for example, the first drone and the first vehicle are selected such that the drone arrives at the destination earlier, whereby it is possible to improve efficiency of delivery of a drone.

In the drone management system according to the first aspect of the disclosure, the first drone may be configured to start flight to the destination of the service when the first vehicle has reached a predetermined point. With this, since a flight distance of the first drone is from the predetermined point to the destination of the service, the first vehicle moves to the predetermined point, whereby it is possible to shorten the flight distance of the first drone.

In the drone management system according to the aspect of the disclosure, the controller may be configured to i) set a reachable point of the first vehicle within a predetermined range from the destination of the service as the predetermined point when the first vehicle is not executing a different service and ii) set a point on a route of the first vehicle within the predetermined range from the destination of the service as the predetermined point when the first vehicle is executing a different service. Since the smaller the distance between a point where the first drone starts flight and the destination of the service, the shorter the flight distance of the first drone, it is possible to save electric power of the first drone. Furthermore, since a vehicle that is executing a different service can also be used as the first vehicle, it is possible to improve the use rate of the vehicles.

In the drone management system according to the aspect of the disclosure, the controller may be configured to, when there is a vehicle where at least one drone lands on the landing field, perform both of: i) selecting, as the first vehicle, the vehicle where at least one drone lands on the landing field, and ii) selecting the first drone from among the at least one drone that lands on the vehicle selected as the first vehicle. With this, for example, it is possible to suppress the occurrence of a waiting time until the first drone and the first vehicle join each other, and to deliver the drone to the destination earlier. Furthermore, it is possible to save electric power that is consumed when the first drone flies to the first vehicle.

In the drone management system according to the aspect of the disclosure, the controller may be configured to perform, when there is no vehicle where at least one drone lands on the landing field within a first range from a first via-point or the destination in the service, the first via-point being a via-point that the first vehicle or the first drone stops by for the first time, any one of: i) selecting, as the first vehicle, a vehicle where any drone within the first range from the first via-point or the destination does not land and selecting, as the first drone, a drone that does not land on any vehicle within a second range from the vehicle selected as the first vehicle, and ii) selecting, as the first drone, a drone that does not land on any vehicle within the first range from the first via-point or the destination and selecting, as the first vehicle, a vehicle where any drone within the second range from the drone selected as the first drone does not land.

When there is no vehicle where a drone lands within the first range from the first via-point or the destination, there is a vehicle where any drone does not land or a drone that does not land on any vehicle, and there is a drone or a vehicle near the vehicle or the drone, there is a high possibility that the drone can be delivered to the destination earlier when the vehicle or drone within the first range and the nearby drone or vehicle join each other, it is possible to improve efficiency of delivery of a drone.

In the drone management system according to the aspect of the disclosure, the controller may be configured to i) select, when there is no vehicle where at least one drone lands on the landing field within a first range from a first via-point that the first vehicle or the first drone stops by for the first time in the service, the first vehicle from among vehicles where any drone within the first range from the first via-point does not land, ii) set, when there is no drone within a second range from the vehicle selected as the first vehicle, the first drone to be unselected, and iii) select, when detection is made that the first vehicle enters within a predetermined range from any one of the first via-point, a via-point subsequent to the first via-point, and the destination, the first drone from among drones within the second range from a current position of the first vehicle.

When there is no drone near the first vehicle at a departure point of the vehicle selected as the first vehicle where any drone within the first range from the first via-point does not land, a drone is searched near the first vehicle again, at any one of the first via-point, the via-point subsequent to the first via-point, and the destination, it is possible to reduce a time spent for drone search or to reduce a waiting time for joining a drone.

In the drone management system according to the first aspect of the disclosure, the controller may be configured to select a second vehicle to be a landing place of the first drone from among vehicles within a predetermined range from a current position of the first drone when predetermined processing of the service at the destination with the first drone ends. With this, the landing destination of the first drone is not limited to the first vehicle where the first drone has taken off any vehicle can be selected, and a degree of freedom is improved.

In the drone management system according to the aspect of the disclosure, the controller may be configured to select the second vehicle from among vehicles where any drone does not, land within the predetermined range from the current position of the first drone. There is a possibility that a vehicle where any drone does not land is seeking a drone that is delivered to the destination. When the vehicle selected as the second vehicle is seeking a drone, it is possible to make a drone, with which the predetermined processing of the service ends, land on the vehicle, to make the drone execute a service that the vehicle selected as the second vehicle is executing, and to effectively use the drone.

In the drone management system according to the aspect of the disclosure, the controller may be configured to decide, when there is a destination of a different service within the predetermined range from the current position of the first drone, flight of the first drone to the destination of the different service. With this, since the drone where the predetermined processing is completed at the destination of the service can be made to fly to the destination of the different service, it is possible to reduce a waiting time for delivery of the drone at the destination of the different service, and to improve the use efficiency of the drone.

In the drone management system according to the first aspect of the disclosure, each of the vehicles may be a vehicle that is able to autonomously travel. The vehicle is able to autonomously travel, whereby it is possible to save human resources.

In the drone management system according to the first aspect of the disclosure, each of the drones may be provided with a secondary battery as a power supply. Each of the vehicles may be provided with a power feed facility that performs power feed to the secondary battery of the drone. With this, since a drone can be charged while landing on a landing field of a vehicle, it is possible to enable a drone to fly for a longer time.

The drone management system may be constituted of one or a plurality of processing devices, such as computers. When the drone management system is constituted of a plurality of processing devices, the configurations of the drone management system are distributed in the processing devices, and the processing devices cooperatively realize processing as the drone management system.

A second aspect of the disclosure relates to a one management method. The drone management method includes causing a management device to receive a request for a service using a drone, the management device being configured to manage a plurality of drones configured to fly and, a plurality of vehicles each provided with a landing field where at least one of the drones is able to take off and land, causing the management device to acquire positional relationships between the drones and the vehicles, causing the management device to select a first drone that flies to a destination of the service from among the drones and select a first vehicle as a landing destination of the first drone from among the vehicles based on the positional relationships between the drones and the vehicles, and, causing the first vehicle and the first drone to provide the service based on the selection. A technical idea disclosed regarding the drone management system described above can also be applied to the drone management method within a range in which a technical contradiction does not occur.

According to the aspects of the disclosure, it is possible to improve efficiency of delivery of a drone in a system that delivers a drone to a destination.

### BRIEF DESCRIPTION OF THE DRAWINGS

Features, advantages, and technical and industrial significance of exemplary embodiments of the disclosure will be described below with reference to the accompanying drawings, in which like numerals denote like elements, and wherein:

FIG. 1 is a diagram showing an example of a system configuration of a drone management system according to a first embodiment;

FIG. 2 is a block diagram showing an example of a hardware configuration of a vehicle;

FIG. 3 is a block diagram showing an example of a hardware configuration of a control system mounted in an electric vehicle (EV) pallet and, each, unit related to the control system;

FIG. 4 is a block diagram illustrating a hardware configuration of a center server;

FIG. 5 is a block diagram showing an example of a hardware configuration of a drone;

FIG. 6 is a block diagram showing an example of a functional configuration of the drone management system;

FIG. 7 shows an example of a service management information table;

FIG. 8 shows an example of a drone management information table;

FIG. 9 shows an example of a vehicle management information table;

FIG. 10A shows an example of a flowchart of processing in a center server when a request for a service using a drone is received;

FIG. 10B shows an example (part 1) of a flowchart of processing in the center server when a request for a service using a drone is received;

FIG. 10C shows the example (part 2) of a flowchart of processing in the center server when a request for a service, using a drone is received;

FIG. 11 shows an example of a flowchart of decision processing of a delivery vehicle and a delivery drone in the center server;

FIG. 12 shows an example of a flowchart of drone landing destination decision processing in the center server;

FIG. 13A is a diagram showing an example of a processing sequence in Specific Example 1;

FIG. 13B is a diagram showing, an example of the processing sequence in Specific Example 1;

FIG. 14A is a diagram showing an example of a processing sequence in Specific Example 2;

FIG. 14B is a diagram showing an example of the processing sequence in Specific Example 2;

FIG. 15A is a diagram showing an example (part 1) of a processing sequence in Specific Example 3;

FIG. 15B is a diagram shoving, the example (part 2) of the processing sequence in Specific Example 3;

FIG. 15C is a diagram showing an example (part 1) of the processing sequence in Specific Example 3;

FIG. 15D is a diagram showing the example (part 2) of the processing sequence in Specific Example 3;

FIG. 16A is a diagram showing an example of a processing sequence in Specific Example 4;

FIG. 16B is a diagram showing an example (part 1) of the processing sequence in Specific Example 4; and

FIG. 16C is a diagram showing, the example (part 2) of the processing sequence in Specific Example 4.

### DETAILED DESCRIPTION OF EMBODIMENTS

Hereinafter, an embodiment of the disclosure will be described based on the drawings. The configuration of the following embodiment is illustrative, and the disclosure is not limited to the configuration of the embodiment.

EV Pallet

In the embodiment, an autonomous traveling electrified vehicle, called an electric vehicle (EV) pallet, provides various functions or, services to a user in cooperation with a computer system on a network. The EV pallet (hereinafter, simply referred, to as an “EV pallet”) of the embodiment is a moving object capable of autonomous driving and unmanned driving. There are EV pallets having various sizes according to purposes. For example, various EV pallets including a small EV pallet capable of being used instead of a suitcase and a large EV pallet capable of carrying a person or an article can be used.

The EV pallet has an information processing device and a communication device that are provided for control of the EV pallet, provision of a user interface with a user who uses the EV pallet, exchange of information with various servers on a network, and the like. The EV pallet provides the user with functions and services to be added by various servers on the network in cooperation with various servers on the network, in addition to processing to be executable by the EV pallet alone.

### First Embodiment

System Outline

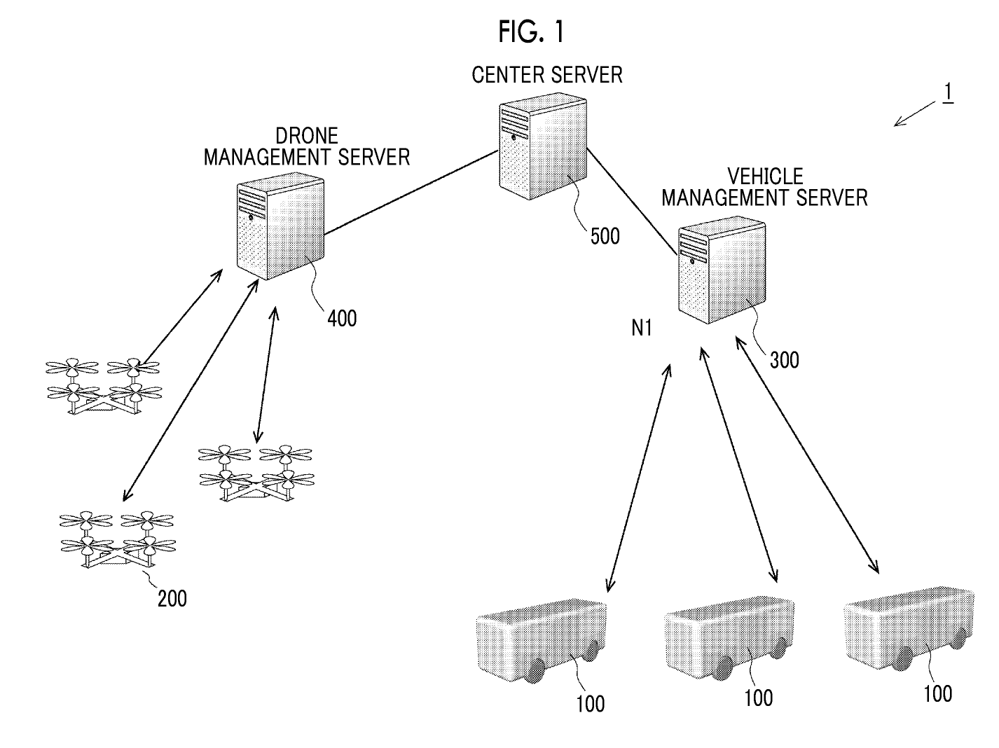

FIG. 1 is a diagram showing an example of the system configuration of a drone management system 1 according to a first embodiment. The drone management system 1 includes a vehicle management server 300 that manages a plurality of vehicles 100, a drone management server 400 that manages a plurality of drones 200, and a center server 500 that performs management of a service using a drone. Each of the drones 200 is connected to the Internet through, a wireless communication network and is connected to the drone management server 400 through the Internet, for example. Each of the vehicles 100 is connected to the Internet through a wireless communication network and is connected to the vehicle management server 300 through the Internet, for example. The vehicle 100 and the drone 200 perform wireless communication, for example, based on the standard of a mobile communication, such as 3G, or long term evolution (LTE), LTE-Advanced, or wireless LAN, such as WiFi.

The vehicle management server 300, the drone management server 400, and the center server 500 are connected, for example, through a local area network (LAN) or a virtual private network (VPN). The vehicle management server 300, the drone management server 400, and the center server 500 may be connected, for example, through a public network.

The vehicle 100 is, for example, an EV pallet. The EV pallet is a moving object that is capable of autonomous driving and unmanned driving to carry a person or an article. The EV pallet has a user interface under computer control, receives a request from a user, responds to the user, executes predetermined processing to the request from the user, and reports a processing result to the user. For example, the EV pallet receives a voice, an image, or an instruction of the user from input/output equipment of the computer and executes processing. The EV pallet recognizes the user from the image, the voice, or the like of the user and follows the user with movement of the user. However, in regard to a request, unprocessable by the EV pallet alone among the requests from the user, the EV pallet notifies the vehicle management server 300 of the request from the user and executes processing in cooperation with the vehicle management server 300. As the request unprocessable by the EV pallet alone, for example, a request for acquisition of information from a database on the vehicle management server 300, a request for recognition or inference with a learning machine, or the like is exemplified. The vehicle 100 is not limited to the EV pallet, and may be, for example, a truck that a person performs driving.

The vehicle 100 receives an operation command from the vehicle management server 300, creates an operation plan, and performs autonomous traveling to a destination based on the operation plan. The vehicle 100 is provided with a landing field where a drone is able to take off and land and can carry the drone landing on the landing field to a predetermined place. The vehicle 100 is provided with a power feed facility in the landing field of the drone, and the drone landing the landing field can perform charging during landing on the landing field of the vehicle 100.

The drone 200 is an unmanned aircraft. The drone 200 receives a flight command from the drone management server 400 to create a flight plan and flies to a destination based on the flight plan. The drone 200 may have the landing field provided in the vehicle 100 as the destination. The flight command from the drone management server 400 also includes information of a flight start position of the drone 200, and the drone 200 starts a flight when arriving at the flight start position.

The vehicle 100 and the drone 200 are each provided with acquisition units to acquire positional information, acquire the positional information in a predetermined cycle, and transmit the positional information to the vehicle management server 300 or the drone management server 400.

The vehicle management server 300 performs management of the vehicle 100. Specifically, the vehicle management server 300 manages, for example, the positional, information of the vehicle 100, information relating to a service allocated to the vehicle 100, information of the drone mounted on the vehicle 100, and the like.

The drone management server 400 performs management of the drone 200. Specifically, the drone management server 400 manages, for example, the positional information of the drone 200, information relating to a service that the drone 200 is performing, and information of the vehicle 100 where the drone 200 lands.

When a request for a service using the drone 200 is received, the center server 500 acquires the positional information of the vehicle 100 or the drone 200 from the vehicle management server 300 and the drone management server 400 and decides the drone 200 and the vehicle 100 that perform the service. Hereinafter, the drone that performs the service is referred to as a “delivery drone”, and the vehicle that performs the service is referred to as a “delivery vehicle”. The center server 500 notifies the vehicle management server 300 of information related to the service, such as a destination of the service and via-points, along with a use request of the delivery vehicle, the vehicle management server 300 transmits an operation command to the vehicle 100 selected as the delivery vehicle. The center server 500 notifies the drone management server 400 of information related to the service, such as the destination of the service and the via-points, along with a use request of the delivery drone, and the drone management server 400 transmits an operation command to the drone 200 selected as the delivery drone.

Examples of the service using the drone 200 to be received by the center server 500 include delivery of a package with the drone, rental of the drone 200, and the like. In a delivery service of a package, for example, the vehicle 100 that is performing a different service and is going to a pick-up place or the vehicle 100 that is on standby is selected as the delivery vehicle, the vehicle 100 loads a package at the pick-up place, when the drone 200 does not land on the vehicle 100, the drone 200 and the vehicle 100 are made to join each other, and when the vehicle 100 approaches a delivery destination, the drone 200 takes off from the vehicle 100 and carries the package to the destination.

In a rental service of a drone, for example, the vehicle 100 that goes toward a rental destination is selected as the delivery vehicle, when the drone 200 does not land on the vehicle 100, the drone 200 and the vehicle 100 are made to join each other until the rental destination, and when the vehicle 100 approaches the rental destination, the drone 200 takes off from the vehicle 100 and arrives at the rental destination. In the first embodiment, joining of the vehicle 100 and the drone 200 indicates that the drone 200 lands on the landing field of the vehicle 100.

Even in any services, after the service ends, the center server 500 selects, as a return destination of the drone 200, for example, the vehicle. 100 that is closest to the drone 200 or the vehicle 100 that goes toward a destination of a different service, and instructs the delivery drone 200 to move to the selected vehicle 100 through the drone management server 400.

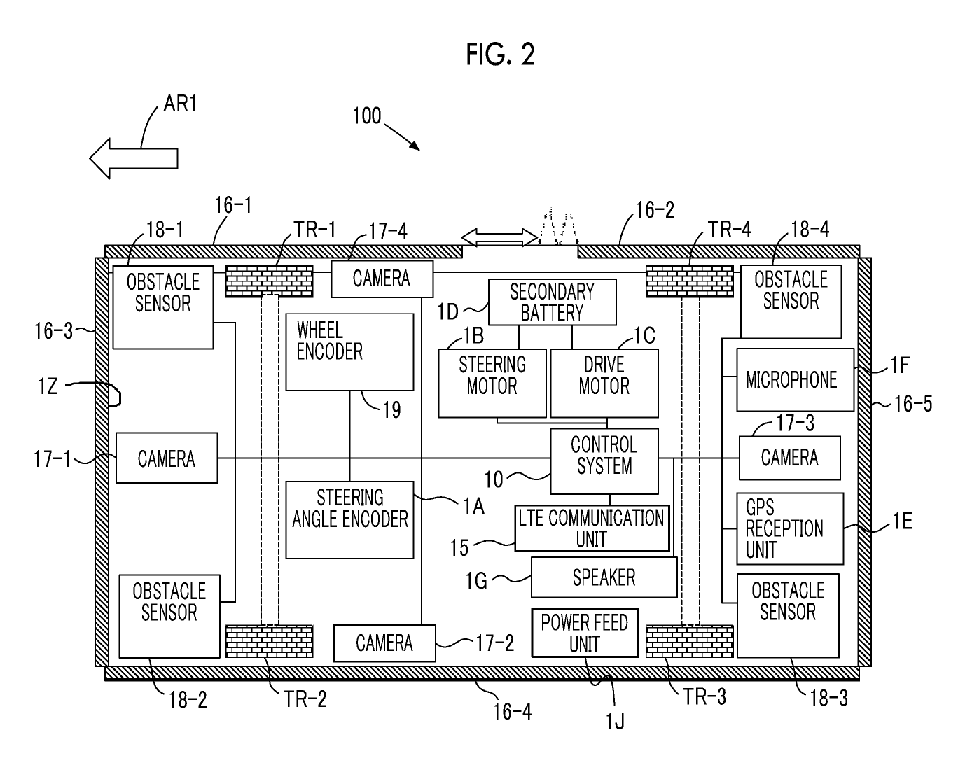

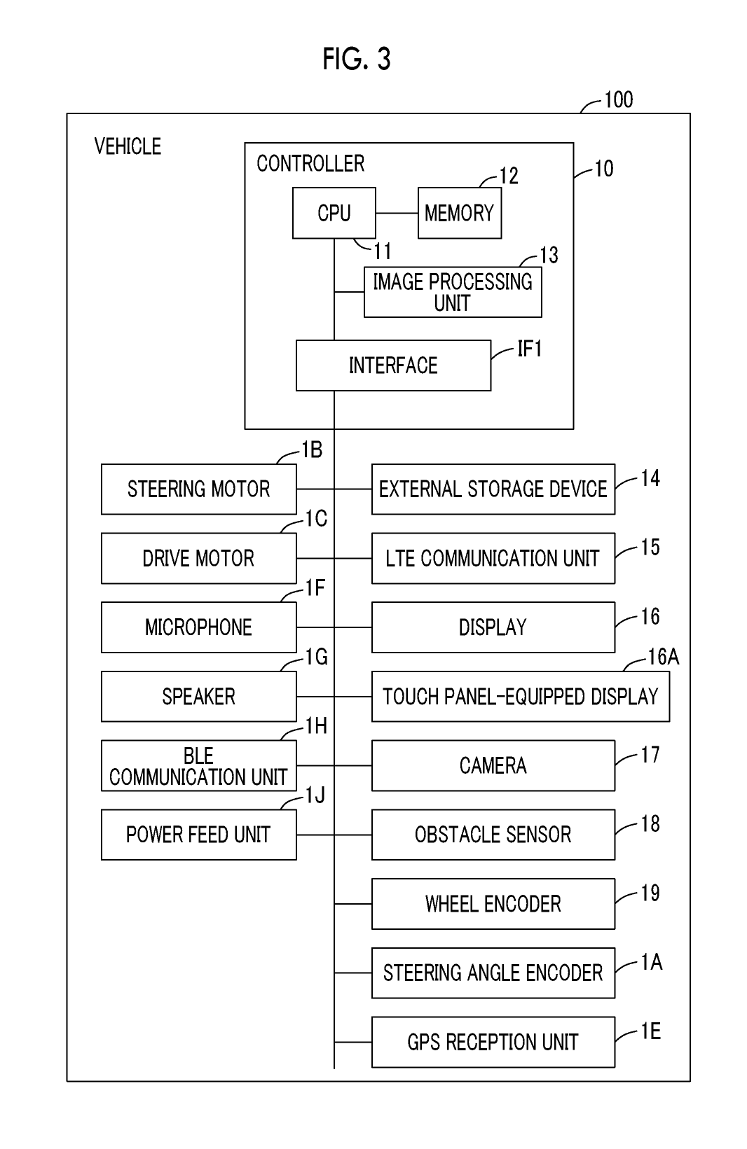

FIG. 2 is a diagram showing an example of the hardware configuration of the vehicle 100. FIG. 2 is a diagram showing a case where an EV pallet is employed as the vehicle 100. The example shown in FIG. 2 is an example of a plan view of the vehicle 100 when viewed from below. FIG. 3 is a diagram showing an example of the hardware configuration of a control system 10 mounted in the EV pallet and each unit related to the control system 10. In FIGS. 2 and 3, the vehicle 100 is described as an EV pallet 100.

The EV pallet 100 has a box-shaped body 1Z and four wheels TR-1 to TR-4 provided in front and rear with respect to a moving direction on both sides below the body 1Z. The four wheels TR-1 to TR-4 are coupled to a drive shaft (not shown) and are driven by a drive motor 1C illustrated in FIG. 2. A moving direction, of the four wheels TR-1 to TR-4 during traveling (a direction parallel to the rotating surface of each of the four wheels TR-1 to TR-4) is displaced relatively with respect to the body 1Z by a steering motor 1B illustrated in FIG. 2, and the moving direction is controlled.

As in FIG. 2, displays 16-1 to 16-5 are fixed to the outer wall of the body 1Z of the EV pallet 100. The displays 16-1 to 16-5 are, for example, liquid crystal displays, electroluminescence panels, or the like. The displays 16-1 to 16-5 are collectively referred to as a display 16 when there is no need for individual distinction.

In FIG. 2, it is assumed that the EV pallet 100 is moving in a direction of an arrow AR1. Accordingly, it is assumed that a left, direction of FIG. 2 is a moving direction. Thus, in FIG. 2, a side surface of the body 1Z in the moving direction is referred to as a front surface of the EV pallet 100, and a side surface in a direction opposite to the moving direction is referred to as a rear surface of the EV pallet 100. A side surface on a right side with respect to the moving direction of the body 1Z is referred to as a right side surface, and a side surface on a left side is referred to as a left side surface.

As in FIG. 2, the EV pallet 100 has obstacle sensors 18-1, 18-2 at positions close to corner portions on both sides of the front surface, and has obstacle sensors 18-3, 18-4 at positions close to corner portions on both sides of the rear surface. Furthermore, the EV pallet 100 has cameras 17-1, 17-2, 17-3, 17-4 in the front surface, the left side surface, the rear surface, and the right side surface, respectively. In the embodiment, the obstacle sensor 18-1 and the like are collectively referred to as an obstacle sensor 18 when there is no need for individual distinction. In the embodiment, the cameras 17-1, 17-2, 17-3, 17-4 are collectively referred to as a camera 17 when there is no need for individual distinction.

The EV pallet 100 has, the steering motor 1B, the drive motor 1C, and a secondary battery 1D that supplies electric power to the steering motor 1B and the drive motor 1C. Furthermore, the EV pallet 100 has a wheel encoder 19 that detects a rotation angle of each wheel, and a steering angle encoder 1A that detects a steering angle as a traveling direction of the wheels. In addition, the EV pallet 100 has the control system 10, an LTE communication unit 15, a GPS reception unit 1E, a microphone 1F, and a speaker 1G. Though not shown, the secondary battery 1D also supplies electric power to the control system 10 and the like. However, a power supply that supplies electric power to the control system 10 and the like may be provided separately from the secondary battery 1D that supplies electric power to the steering motor 18 and the drive motor 1C.

The EV pallet 100 is provided with a power feed unit 1J that performs power feed to the drone 200. A power feed method to the drone 200 may be, for example, a method that performs power feed by bringing the terminals of the power feed unit 1J and the drone 200 into contact with each other and making a current flow through the terminals in contact with each other, or wireless power feed in which the power feed unit 1J has a coil, electric power flows in the coil to generate a magnetic field, and the magnetic field is received by a coil in the drone 200, thereby obtaining electric power.

The control system 10 is also referred to as an engine control unit (ECU). As in FIG. 3, the control system 10 has a central processing unit (CPU) 11, a memory 12, an image processing unit 13, and an interface IF1. An external storage device 14, the LTE communication unit 15, the display 16, a touch panel-equipped display 16A, the camera 17, the obstacle sensor 18, the wheel encoder 19, the steering angle encoder 1A, the steering, motor 1B, the drive motor 1C, the GPS reception unit 1E, the microphone 1F, the speaker 1G, a Bluetooth low energy (BLE) communication unit 1H, a power feed unit 1J, and the like are connected to the interface IF1.

The obstacle sensor 18 is an ultrasonic sensor, a radar, or the like. The obstacle sensor 18 emits an ultrasonic wave, an electromagnetic wave, or the like in a detection target direction and detects the presence, position, relative speed, and the like of an obstacle in the detection target direction based on a reflected wave.

The camera 17 is an imaging device constituted of an image sensor, such as charged-coupled devices (CCD), metal-oxide-semiconductor (MOS), or complementary metal-oxide-semiconductor (CMOS). The camera 17 acquires images at a predetermined time interval, called a frame cycle, and stores the images in a frame buffer (not shown) in the control system 10. The images stored in the frame buffer in the frame cycle are referred to as frame data.

The steering motor 1B controls a direction of a cross line, along which the rotating surface of the wheel crosses a horizontal plane, that is, an angle to be a moving direction with the rotation of the wheel, in response to an instruction signal from the control system 10. The drive motor 1C drives and rotates, for example, the wheels TR-1 to TR-4 in response to an instruction signal from the control system 10. However, the drive motor IC may drive a pair of wheels TR-1, TR-2 or another pair of wheels TR-3, TR-4 from among the wheels TR-1 to TR-4. The secondary battery 1D supplies electric power to the steering motor 1B, the drive motor 1C, and parts connected to the control system 10.

The steering angle encoder 1A detects the direction of the crossline, along which the rotating surface of the wheel crosses the horizontal plane, (or an angle of the rotation axis of the wheel within the horizontal plane) to be the moving direction with the rotation of the wheel at a predetermined detection time interval and stores the direction in a register (not shown) of the control system 10. For example, an origin of an angle is set in a direction of the rotation axis of the wheel orthogonal to the moving direction (the arrow AR1 direction) in FIG. 2. Furthermore, the wheel encoder 19 acquires a rotation speed of the wheel at predetermined detection time interval and stores the rotation speed in the register (not shown) of the control system 10.

The LTE communication unit 15 is, for example, a communication unit that performs communication with various servers on the network through a mobile phone base station and a public communication network connected to the mobile phone base station. The LTE communication unit 15 performs wireless communication using a wireless signal and a wireless communication system based on the standard of LTE. The Bluetooth low energy (BLE) communication unit 1H is, for example, a communication unit that transmits a BLE signal for notifying the drone 200 of the presence of the vehicle 100 in a predetermined cycle. The BLE signal includes, for example, identification information of the vehicle 100.

The global positioning system (GPS) reception unit 1E receives an electric wave of a time signal from each of a plurality of artificial satellites (Global Positioning Satellite) revolving around the earth and stores the electric wave of the time signal in the register (not shown) of the control system 10. The microphone 1F detects voice, converts voice to a digital signal, and stores the digital signal in the register (not shown) of the control system 10. The speaker 1G is driven by a D/A converter and an amplifier connected to the control system 10 or a signal processing unit (not shown) and reproduces audio including sound and voice.

The CPU 11 of the control system 10 executes a computer program developed to be executable in the memory 12 and executes processing as the control system 10. The memory 12 stores the computer program to be executed on the CPU 11, data to be processed by the CPU 11, and the like. The memory 12 is, for example, a dynamic random access memory (DRAM), a static random access memory (SRAM), a read only memory (ROM), or the like. The image processing unit 13 cooperates with the CPU 11 and processes data of the frame buffer obtained from the camera 17 in each predetermined frame cycle. The image processing unit 13 has, for example, a GPU and an image memory to be the frame buffer. The external storage device 14 is a nonvolatile storage device, and is, for example, a solid state drive (SSD), a hard disk drive, or the like.

For example, as in FIG. 3, the control system 10 acquires detection signals from the units and the sensors of the EV pallet 100 through the interface IF1. The control system 10 calculates a latitude and a longitude indicating a position on the earth based on a detection signal from the GPS reception unit 1E. The control system 10 acquires map data from a map information database stored in the external storage device 14, collates the calculated latitude and longitude with a position on map data, and decides a current location. The control system 10 acquires a route from the current location to a destination on map data. The control system 10 detects an obstacle in the vicinity of the EV pallet 100 based on signals from the obstacle sensor 18, the camera 17, and the like, decides a moving direction so as to avoid the obstacle, and controls a steering angle.

The control system 10 cooperates with the image processing unit 13, processing images acquired from the camera 17 for each frame data, detects change based on the difference between the images, for example, and recognizes an obstacle. The control system 10 recognizes a user with each piece of frame data of the images from the camera 17, maintains a distance from the user to a predetermined value, and follows movement of the user. The control system 10 recognizes a gesture of the user in frame data of the images from the camera 17 and responds to the intention of the user obtained from the recognized gesture. The control system 10 analyzes a voice signal obtained from the microphone 1F and responds to the intention of the user obtained from voice recognition. The control system 10 may transmit frame data of the images from the camera 17 and voice data obtained from the microphone 1F from, the LTE communication unit 15 to the vehicle management server 300 on the network. Then, analysis of frame data of the images and voice data may be assigned to the vehicle management server 300.

The control system 10 displays an image, a character, and other kinds of information on the display 16. The control system 10 detects an operation on the touch panel-equipped display 16A and receives an instruction from the user. The control system 10 responds from the display 16, the touch panel-equipped display 16A, or the speaker 1G to an instruction from the user through the touch panel-equipped display 16A, the camera 17, and the microphone 1F.

In FIG. 3, although the interface IF1 is illustrated, exchange of a signal between the control system 10 and a control target is not always limited to the interface IF1. That is, the control system 10 may have a plurality of signal exchange paths other than the interface IF1. In FIG. 3, the control system 10 has the single CPU 11. However, the CPU is not always limited to a single processor and may have a multi-processor configuration. A single CPU that is connected with a single socket may have a multi-core configuration. At least a part of the processing of the units described above may be executed a processor other than the CPU, for example, a dedicated processor, such as a digital signal processor (DSP) or a graphics processing unit (GPU). At least a part of the processing of the units described above may be an integrated circuit (IC) or other digital circuits. An analog circuit may be included in at, least a part of the units.

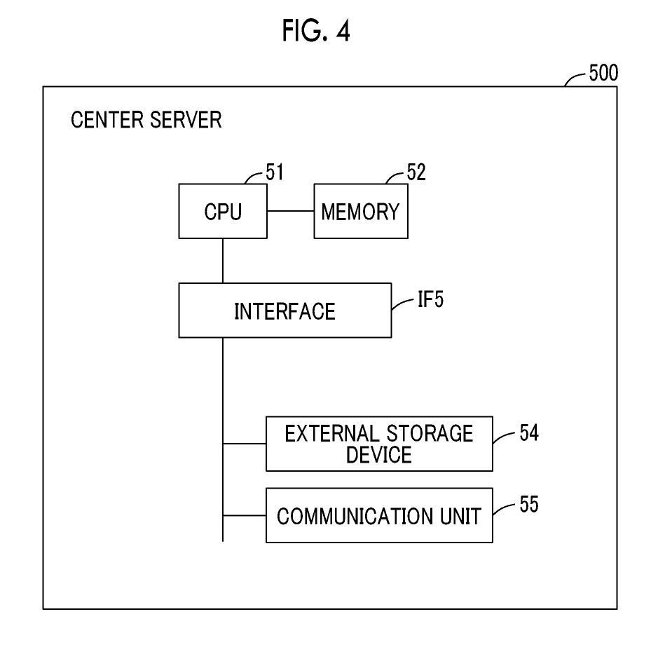

FIG. 4 is a diagram illustrating the hardware configuration of the center server 500. The center server 500 has a CPU 51, a memory 52, an interface IF5, an external storage device 54, and a communication unit 55. The configurations and operations of the CPU 51, the memory 52, the interface IF5, and the external storage device 54 are the same as those of the CPU 11, the memory 12, the interface IF1, and the external storage device 14 of FIG. 3. The communication unit 55 is connected to a public communication network through a LAN and performs communication with various servers on the network through the public communication network, for example.

Similarly to the center server 500, each of the vehicle management server 300 and the drone management server 400 includes a CPU, a memory, an interface, an external storage device, and a communication unit, and the configurations and operations thereof are the same as those of the CPU 51, the memory 52, the interface IF5, the external storage device 54, and the communication unit 55 of the center server 500. For this reason, the hardware configuration of the vehicle management server 300 and the drone management sever 400 will not be shown.

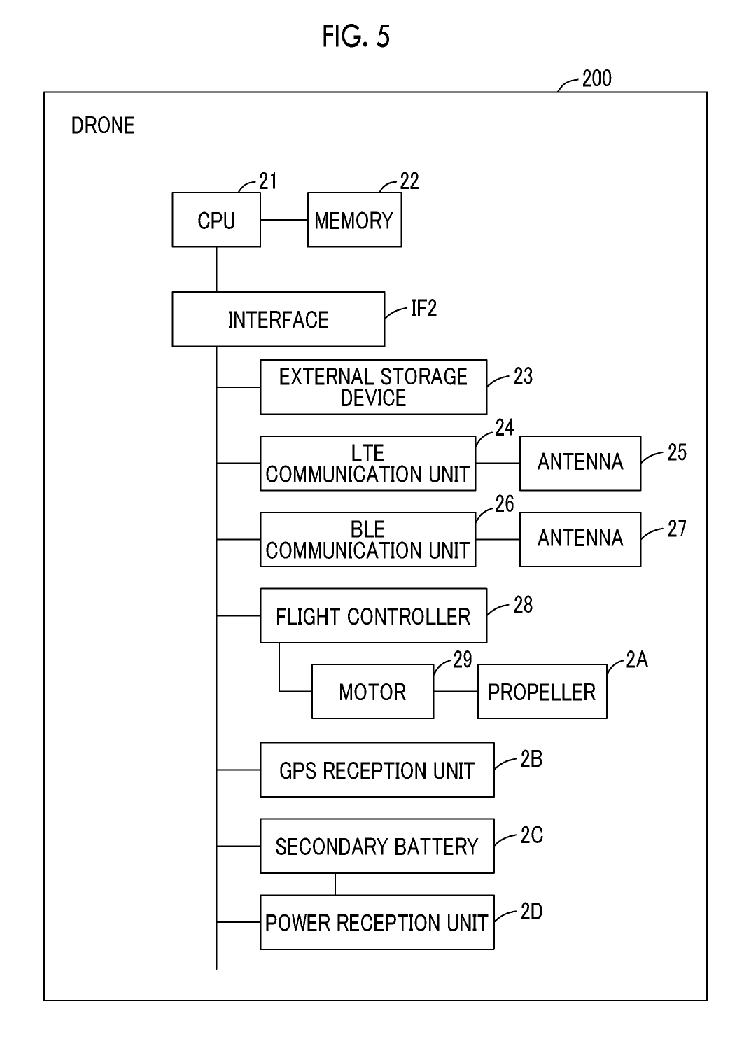

FIG. 5 is a diagram showing an example of the hardware configuration of the drone 200. The drone 200 includes a CPU 21, a memory 22, an interface IF2, an external storage device 23, an LTE communication unit 24, an antenna 25, a BLE communication unit 26, an antenna 27, a flight controller 28, motors 29, propellers 2A, a GPS reception unit 2B, a secondary battery 2C, and a power reception unit 2D.

The configurations and operations of the CPU 21, the memory 22, the interface IF2, and the external storage device 23 are the same as those of the CPU 11, the memory 12, the interface IF1, and the external storage device 14 of FIG. 3.

The LTE communication unit 24 is a communication unit that performs communication with various servers on the network, in particular, the drone management server 400 and the like through a mobile phone base station and a public communication network connected to the mobile phone base station. The antenna 25 is connected to the LTE communication unit 24 and receives and transmits a wireless signal of LTE. Wireless communication for connection to the public communication network in the drone 200 is not limited to LTE.

The BLE communication unit 26 is a communication unit that receives a BLE signal and recognizes the presence of the vehicle 100. For example, the BLE signal that is transmitted from the vehicle 100 includes the identification information of the vehicle 100. For example, since a moving speed of the vehicle 100, the distance from the vehicle 100, and the like can be acquired based on reception intensity of the BLE signal, when the drone 200 lands on the vehicle 100, landing is performed depending on the BLE signal transmitted from the vehicle 100. The BLE signal that is transmitted from the vehicle 100 may include positional information of the vehicle 100. The antenna 27 is an antenna that receives the BLE signal.

The flight controller 28 controls drive and stop of the motors 29 or controls each of a plurality of propellers 2A to control a moving direction, thereby controlling a flight based on a flight plan input from the CPU 21, for example. The flight plan includes, for example, information of a flight start position, a destination, a flight route to the destination, processing to be executed at a predetermined point, and the like. The destination is indicated by a combination of a latitude, a longitude, and an altitude or a combination of an address and an altitude, for example. When the landing field of the vehicle 100 is a destination, for example, the destination is indicated by the identification information of the vehicle 100. The flight controller 28 also performs control of landing on the landing field of the vehicle 100 based on the BLE signal transmitted from the vehicle 100 as one of control for a flight based on the flight plan, for example. The motors 29 and the propellers 2A are plural. However, in FIG. 5, solely one motor and one propeller are shown for convenience.

The GPS reception unit 2B receives an electric wave of a time signal from each of a plurality of artificial satellites revolving around the earth and stores the electric wave of the time signal in a register (not shown). The CPU 21 calculates a latitude, a longitude, and an altitude indicating a position on the earth, for example, as positional information based on a detection signal from the GPS reception unit 2B in a predetermined cycle and transmits the acquired positional information to the drone management server 400 through the LTE communication unit 24.

The secondary battery 2C supplies electric power to the CPU 21, the external storage device 23, the LTE communication unit 24, the BLE communication unit 26, the flight controller 28, the motor 29, and the GPS reception unit 2B, for example. The secondary battery 2C is charged with electric power to be input through the power reception unit 2D.

The power reception unit 2D is the power reception unit 2D that receives electric power to be charged in the secondary battery 2C from the vehicle 100 when the drone 200 lands on the landing field of the vehicle 100. For example, when a charging system from the vehicle 100 is a connection system, the power reception unit 2D is a terminal, a connector, a plug, or the like. In this case, the power reception unit 2D may be housed in the body of the drone, and when detection is made that the drone 200 lands on the vehicle 100, may be pulled out under the control of the CPU 21. For example, when a charging system from the vehicle 100 is a noncontact system, the power reception unit 2D is a coil.

The hardware configuration of the drone 200 shown in FIG. 5 is an example, and the hardware configuration of the drone 200 is not limited to that shown in FIG. 5. The drone 200 further includes a gyro sensor, an acceleration sensor, an azimuth sensor, an air pressure sensor, a sound wave sensor, and the like in order to ascertain the posture, position, altitude, and the like of the drone 200. These sensors are not shown in FIG. 5.

The hardware configuration of the drone 200 can be added, changed, and deleted according to a use purpose of the drone, for example. For example, when the drone 200 is used for delivery of a package, the drone 200 is provided with fixing member, such as a sucker, magnetic force, or wire, for fixing the package to the drone 200.

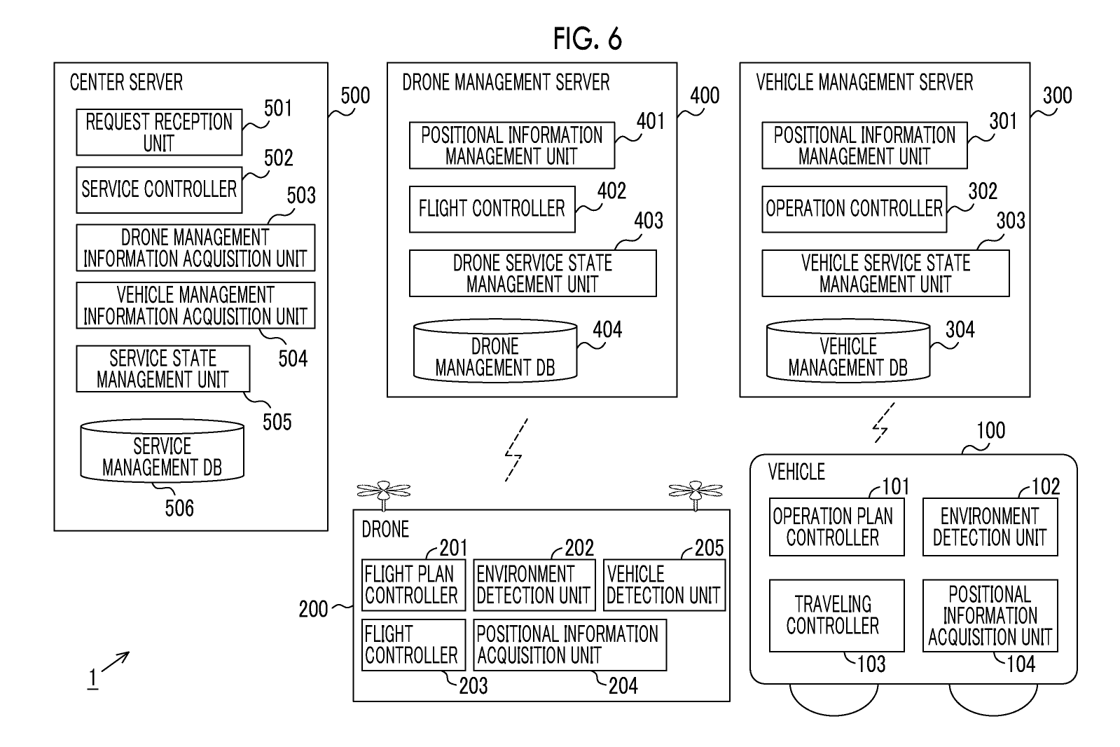

FIG. 6 is a diagram showing an example of the functional configuration of the drone management system 1. The center server 500 operates as each unit illustrated in FIG. 6 according to a computer program on the memory 52. The center server 500 includes, as functional constituent elements, a request reception unit 501, a service controller 502, a drone management information acquisition unit 503, a vehicle management information acquisition unit 504, a service state management unit 505, and a service management database (DB) 506.

The request reception unit 501 receives a request for a service using a drone. The request for a service using a drone is received from a delivery management server of a delivery agent, a user terminal of an individual user, or the like, for example. Information of a destination of the service, via-points, and the like is also input along with the request for the service. For example, when the requested service is a delivery service, information of a delivery destination of a package as a destination and a pick-up place of the package as a via-point is also input to the request reception unit 501. For example, when the requested service is a rental service of the drone 200, information of a rental destination of the drone 200 as a destination is also input to the request reception unit 501. However, when the requested service is a rental service, information of via-points may not be input. The request reception unit 501 is an example of a “reception unit”.

When the request for the service is received by the request reception unit 501, the service controller 502 decides a delivery vehicle and a delivery drone that perform the service. In addition, the service controller 502 decides a drone transportation destination that is a transportation destination of the delivery drone by the delivery vehicle and is a flight start position (take-off point) of the delivery drone. The service controller 502 performs control of the vehicle management server 300 and the drone management server 400 such that the delivery vehicle and the delivery drone move to the drone transportation destination, the delivery drone starts flight to the destination at the drone transportation destination, and the drone executes predetermined processing at the destination. Details of the processing of the service controller 502 will be described below. When an inquiry regarding a return destination of the drone 200 where execution of the predetermined processing is completed at the destination of the service is received, the service controller 502 decides the vehicle 100 to be a landing destination of the drone 200 based on the positional information of the drone 200. The service controller 502 is an example of a “controller”. The delivery vehicle is an example of a “first vehicle”. The delivery drone is an example of a “first drone”.

The drone management information acquisition unit 503 acquires drone management information from the drone management server 400 according to an instruction from the service controller 502, for example. The drone management information includes, for example, the positional information of the drone 200 and information of the vehicle 100 where the drone 200 lands. Details of the drone management information will be described below. The drone management information acquisition unit 503 is an example of an “acquisition unit”.

The vehicle management information acquisition unit 504 acquires vehicle management information from the vehicle management server 300 according to an instruction from the service controller 502, for example. The vehicle management information includes, for example, the positional information of the vehicle 100 and information of the drone 200 that lands on the vehicle 100. Details of the vehicle management information will be described below. The vehicle management information acquisition unit 504 is an example of an “acquisition unit”.

The service state management unit 505 manages a state of the service to be performed by the vehicle 100 and the drone 200. For example, in regard to a service where a service completion notification is received from the delivery vehicle through the vehicle management server 300 and a service completion notification is received from the delivery drone through the drone management server 400, the service state management unit 505 updates a service state in the service management DB 506 described below to “SERVICE COMPLETION”. Although there is also a service using the vehicle 100 solely other than the service using the drone 200, and the center server 500 receives a request for a service using the vehicle 100 solely, in the first embodiment, description of control related to a service using the vehicle 100 solely will be omitted.

The service management DB 506 is created in the external storage device 54 of the center server 500, for example. The service management DB 506 stores a service management information table that holds information related the service using the vehicle 100 or the drone 200 receiving the request with the request reception unit 501. Details of the service management information table will be described below.

Next, the drone management server 400 operates as each unit illustrated in FIG. 6 according to a computer program on the memory. The drone management server 400 includes, as functional constituent elements, a positional information management unit 401, a flight controller 402, a drone service state management unit 403, and a drone management DB 404.

The positional information management unit 401 receives the positional information of the drone 200 transmitted from the drone 200 in a predetermined cycle and registers the positional information in the drone management DB 404 described below. The flight controller 402 receives a use request of the drone 200 and information relating to the service from the center server 500, for example. Information relating to the service includes information of a destination of the service, via-points, a drone transportation destination, the vehicle 100 where the drone 200 lands, and the like.

The flight controller 402 performs control relating to a flight of the drone 200 by performing a response to the use request of the drone 200 from the center server 500, creating a flight command according to the take-off point (drone transportation destination), the destination, the vehicle where the drone lands, and the like included in information relating to the service, and transmitting the flight command to the drone 200, or the like. The flight command created by the flight controller 402 includes, for example, a command for landing on the vehicle 100, a command for take-off at the drone transportation destination, a command for transportation of a package to the destination, and the like in an execution order. When the inquiry of a landing destination is received from the drone 200, the flight controller 402 transmits the inquiry of the landing destination from the drone 200 to the center server 500. Details of the processing of the flight controller 402 will be described below.

When an inquiry of the drone management information is received from the center server 500, the flight controller 402 reads the drone management information table stored in the drone management DB 404 and transmits the drone management information table to the center server 500 to perform a response.

The drone service state management unit 403 manages a state of the service that the drone 200 executes. For example, when a service end notification is received from the drone 200, the drone service state, management unit 403 updates a service state of the drone 200 in the drone management DB 404 described below to “SERVICE COMPLETION”.

The drone management DB 404 is created in the external storage device of the drone management server 400, for example. The drone management DB 404 stores a drone management information table storing information relating to the drone 200 in the drone management system 1. Details of the drone management DB 404 will be described below.

Next, the drone 200 operates as each unit illustrated in FIG. 6 according to a computer program on the memory. The drone 200 includes, for example, functional constituent elements, a flight plan controller 201, an environment detection unit 202, a flight controller 203, a positional information acquisition unit 204, and a vehicle detection unit 205.

Each of the flight plan controller 201, the positional information acquisition unit 204, and the vehicle detection unit 205 is, for example, a functional configuration that is realized by the CPU 21. The positional information acquisition unit 204 acquires the positional information of the drone 200 acquired from the GPS reception unit 2B, the gyro sensor (not shown), or the like in a predetermined cycle and transmits the positional information of the drone 200 to the drone management server 400, for example. The positional information of the drone 200 is, for example, a latitude, a longitude, and an altitude. Alternatively, the positional information of the drone 200 may be, for example, an address and an altitude. The positional information of the drone 200 acquired by the positional information acquisition unit 204 is also output to the flight plan controller 201 and the flight controller 203, for example.

The vehicle detection unit 205 receives the BLE signal transmitted from the vehicle 100 and detects, from information included in the BLE signal, the vehicle 100 where the drone is scheduled to land or detects the distance from the vehicle 100, for example. Information of the vehicle 100 detected by the vehicle detection unit 205 is output to the flight plan controller 201, for example.

The flight plan controller 201 receives a flight command from the drone management server 400 and generates a flight plan of the host drone. The flight command includes, for example, information relating to the service, a command for landing on the vehicle 100, a command for take-off at the drone transportation destination (take-off point), a command for transportation of a package to the destination, and the like in an execution order. Information relating to the service included in the flight command also includes information of the destination, the via-points, the drone transportation destination, or identification information of a delivery package, information of an addressee, and the like, for example, in a case of a delivery service of a package.

The flight plan controller 201 calculates, as the flight plan, a flight route of the drone 200 based on the vehicle 100 as a landing destination provided from the drone management server 400, the positional information of the drone transportation destination (take-off point), the destination, and the via-points, and the position of the host drone obtained by the positional information acquisition unit 204 and generates the flight plan. In addition, the flight plan includes data that defines processing to be executed by the drone 200 in a part or the whole of the route. Data that defines the processing to be executed by the drone 200 in a part or the whole of the route is, for example, loading a package, unloading a package at the destination, and the like.

In response to the flight plan, the flight plan controller 201 detects the vehicle 100 as the landing destination with the reception of the BLE signal, instructs the flight controller 203 to land on the vehicle 100 as the landing destination, detects arrival at the drone transportation destination (take-off point) or the destination, instructs the flight controller 203 to take off, or instructs the flight controller 203 to unload the package. When the flight plan ends or an input of a service completion notification from the user as a service request source is received, the flight plan controller 201 detects service completion and transmits the service end notification to the drone management server 400.

The environment detection unit 202 and the flight controller 203 are, for example, the functional constituent elements that are realized by the flight controller 28. The environment detection unit 202 detects environment information in the vicinity of the drone 200 for use in an autonomous flight based on data acquired by various sensors in the drone 200. A detection target of the environment detection unit 202 is, for example, information of the posture, position, and altitude of the host drone, the number or positions of obstacles (for example, structures, buildings, poles, wires, flying objects, such as birds, or the like) in the vicinity of the host drone, or the like, but is not limited thereto. Any detection target may be applied as long as the detection target is used to perform an autonomous flight. Data relating to the surrounding environment of the drone 200 detected by the environment detection unit 202 is output to the flight controller 203 described below.

The flight controller 203 generates a control command for controlling the autonomous flight of the host drone, for example, based on data relating to the surrounding environment of the drone 200 generated by the environment detection unit 202 and the positional information of the host drone acquired by the positional information acquisition unit 204 according to an instruction from the flight plan controller 201. For example, when the command for take-off is input from the flight plan controller 201, the flight controller 203 generates a control command for allowing the drone 200 to start take-off, to fly along a predetermined flight route, and to fly the host drone such that an obstacle does not enter within a predetermined safety zone centering on the host drone. The generated control command is transmitted to each motor 29. Each motor 29 is adjusted in rotation in response to the control command from the flight controller 203, whereby a moving direction of the drone 200 is controlled. In regard to a generation method of the control command for making the drone 200 perform an autonomous flight, a known method can be employed.

Next, the vehicle management server 300 operates as each unit illustrated in FIG. 6 according to a computer program on the memory. The vehicle management server 300 includes, as functional constituent elements, a positional information management unit 301, an operation controller 302, a vehicle service state management unit 303, and a vehicle management DB 304.

The positional information management unit 301 receives the positional information of the vehicle 100 transmitted from the vehicle 100 in a predetermined cycle and registers the positional information of the vehicle 100 in the vehicle management DB 304 described below. The operation controller 302 receives a use request of the vehicle 100 and information relating to the service from the center server 500, for example. Information relating to the service includes information of the destination, the via-points, the drone transportation destination, and the like.

The operation controller 302 performs control relating to the operation of the drone 200 by performing a response to the use request of the vehicle 100 from the center server 500, creating an operation command based on information relating to the service and transmitting the operation command to the drone 200, or the like. The operation command created by the operation controller 302 includes, for example, a command for loading of a package at a via-point, a command for transportation of the drone to the drone transportation destination, and the like in an execution order. Details of the processing of the operation controller 302 will be described below.

When an inquiry of the vehicle management information is received from the center server 500, the operation controller 302 reads a vehicle management information table stored in the vehicle management DB 304 and transmits the vehicle management information table to the center server 500 to perform a response.

The vehicle service state management unit 303 manages the state of the service that the vehicle 100 executes. For example, when a service end notification is received from the vehicle 100, the vehicle service state management unit 303 updates a service state of the vehicle 100 in the vehicle management DB 304 described below to “SERVICE COMPLETION”.

The vehicle management DB 304 is created in the external storage device of the vehicle management server 300, for example. The vehicle management DB 304 stores the vehicle management information table storing information relating to the vehicle 100 in the drone management system 1. Details of the vehicle management information table will be described below.

Next, the vehicle 100 operates as each unit illustrated in FIG. 6 according to a computer program on the memory. The vehicle 100 includes, for example, functional constituent elements, an operation plan controller 101, an environment detection unit 102, a traveling controller 103, and a positional information acquisition unit 104.

The positional information acquisition unit 104 acquires the positional information of the vehicle 100 acquired by the GPS reception unit 1E and the like in a predetermined cycle and transmits the positional information of the vehicle 100 to the vehicle management server 300, for example. The positional information of the vehicle 100 is, for example, a latitude and a longitude. Alternatively, the positional information of the vehicle 100 may be, for example, an address. The positional information of the vehicle 100 acquired by the positional information acquisition unit 104 is also output to the operation plan controller 101 and the traveling controller 103, for example.

The operation plan controller 101 receives an operation command from the vehicle management server 300 and generates an operation plan of the host vehicle. The operation command includes, for example, positional information of a drone transportation destination, via-points, and the like, information relating to a package scheduled to be loaded, and the like. Accordingly, the operation plan controller 101 calculates a route, along which the vehicle 100 is to move, based on the positional information of the drone transportation destination, the via-points, and the like provided from the vehicle management server 300 and the positional information of the host vehicle obtained by the positional information acquisition unit 104 and generates the operation plan. The operation plan includes data relating to the thus-calculated route along which the vehicle 100 travels, and data that defines processing to be executed by the vehicle 100 in a part or the whole of the route. As an example of data included in the operation plan, for example, the following (1) and (2) are exemplified.

(1) Data representing traveling route of host vehicle by set of road links. The traveling route of the host vehicle may be automatically generated based on given departure place, via-points, and destination with reference to stored map data, for example. The calculation of the traveling route of the host vehicle may depend on processing of an external device (for example, the vehicle management server 300), instead of the vehicle 100. In this case, the vehicle management server 300 acquires the host vehicle position from the vehicle 100, calculates a route along which the vehicle 100 is to move, and includes calculated route data in the operation command described above.

(2) Data representing processing to be executed by host vehicle at point on route. The processing to be executed by the host vehicle is, for example, “making the user get in” and “loading a package”, but is not limited thereto. The operation plan generated by the operation plan controller 101 is transmitted to the traveling controller 103 described below.

The environment detection unit 102 detects environment information in the vicinity of the vehicle 100 for use in autonomous traveling based on data acquired by various sensors mounted in the vehicle 100. A detection target of the environment detection unit 102 is, for example, information of the number or positions of lanes, the number or positions of vehicles in the vicinity of the host vehicle, the number or positions of obstacles (for example, pedestrians, bicycles, structures, buildings, or the like) in the vicinity of the host vehicle, a structure of a road, road signs, or the like, but is not limited thereto. Any detection target may be applied as long as the detection target is used to perform autonomous traveling. For example, when the sensor is a stereo camera, object detection in the vicinity of the vehicle 100 is performed by executing image processing on image data captured by the stereo camera. The environment detection unit 102 may not only detect an object in the vicinity of the vehicle 100 simply but also track the detected object. The tracking refers to, for example, continuously detecting a detected target. For example, the difference between coordinates of an object detected before one step and current coordinates of the object can be used to obtain a relative speed of the object. Data relating to the surrounding environment of the vehicle 100 detected by the environment detection unit 102 is output to the traveling controller 103 described below.

The traveling controller 103 generates a control command for controlling autonomous traveling of the host vehicle based on the operation plan generated by the operation plan controller 101, data relating to the surrounding environment of the vehicle 100 generated by the environment detection unit 102, and the positional information of the host vehicle acquired by the positional information acquisition unit 104, for example. For example, when a traveling start command is input from the operation plan controller 101, the traveling controller 103 generates a control command for allowing the host vehicle to travel along a predetermined route and to make the host vehicle travel such that an obstacle does not enter a predetermined safety zone centering on the host vehicle. The generated control command is transmitted to the drive motor 1C. In regard to a generation method of the control command for making the vehicle perform autonomous traveling, a known method can be employed.

Any one of the functional constituent elements or a part of the processing of each of the vehicle management server 300, the drone management server 400, and the center server 500 may be executed by a different computer connected to the network. A sequence of processing that is executed by each of the vehicle management server 300, the drone management server 400, and the center server 500 can be executed by hardware, but may be executed by software.

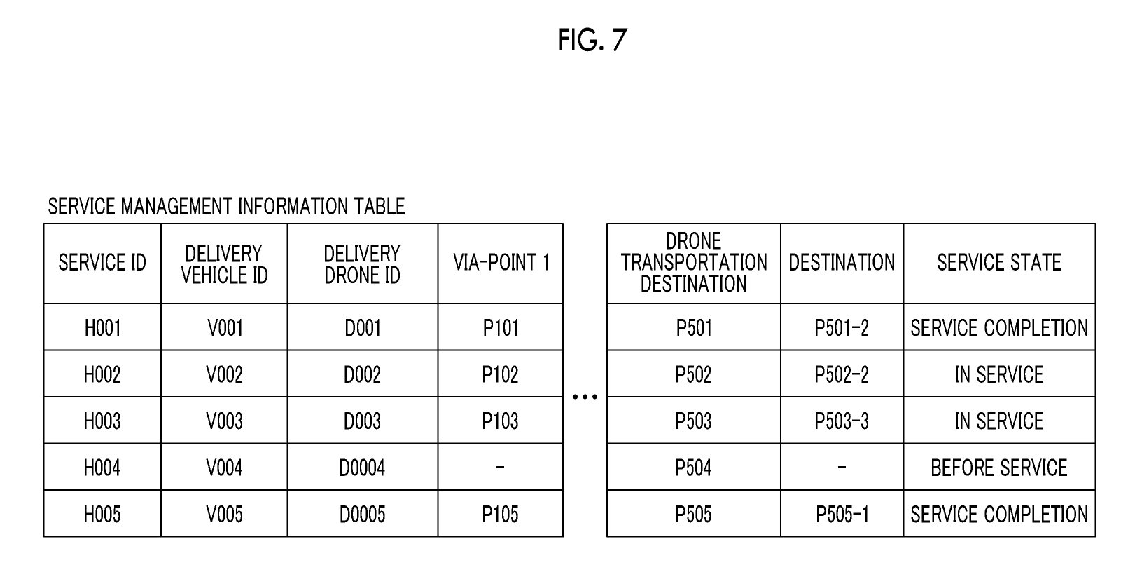

FIG. 7 shows an example of the service management information table. The service management information table is a table that is stored in the service management DB 506 of the center server 500. In the service management information table, for example, information (service management information) related to the service using the drone 200 requested to the center server 500 is stored.

In the service management information table, fields of a service ID, a delivery vehicle ID, a delivery drone ID, a via-point, a drone transportation destination, a destination, and a service state are included. In the field of the service ID, identification information of a service requested to the center server 500 is input. The identification information of the service is given by the request reception unit 501 of the center server 500, for example.

In the fields of the delivery vehicle ID and the delivery drone ID, identification information of the delivery vehicle decided by the service controller 502 of the center server 500 and identification information of the delivery drone decided by the service controller 502 of the center server 500 are input, respectively. The delivery vehicle and the delivery drone may be designated by a request source.

In the fields of the via-point, the destination, and the drone transportation destination, for example, positional information of a via-point, a destination, and a drone transportation destination received along with the request for the service using the drone 200 is input, respectively. The number of via-points is not limited to one, and may be plural depending on the content of the service or may not be set. That is, the via-point is optional. The via-point may be added by the service controller 502. For example, when a request for a delivery service of a package with the drone 200 is received, the via-point is a pick-up place of a package, and the destination is an address of an addressee (in a case of an apartment, a floor number, a room number, or the like) as a delivery destination. The drone transportation destination is, for example, a limit point (vehicle entrance limit point) closest to the address of the addressee where the vehicle 100 can enter. For example, when a request for a rental service of the drone 200 is received, there is no via-point, and the destination is an address of a rental destination. The drone transportation destination is, for example, a vehicle entrance limit point closest to the rental destination. Though described below, the drone transportation destination is decided from the positional information of the destination of the service or the service state of the delivery vehicle by the service controller 502 of the center server 500.

In the field of the service state, for example, any one of “BEFORE SERVICE”, “IN SERVICE”, and “SERVICE COMPLETION” is input. For example, when time designation is included in the requested service and a time is before the time related to the time designation, a value of the field of the service state becomes “BEFORE SERVICE”. For example, when the delivery vehicle and the delivery drone that executes the service are decided, the value of the field of the service state becomes “IN SERVICE”. When service completion notifications from both of the delivery vehicle and the delivery drone are received through the vehicle management server 300 and the drone management server 400, the value of the field of the service state becomes “SERVICE COMPLETION”. The value of the field of the service state is managed by the service state management unit 505 of the center server 500.

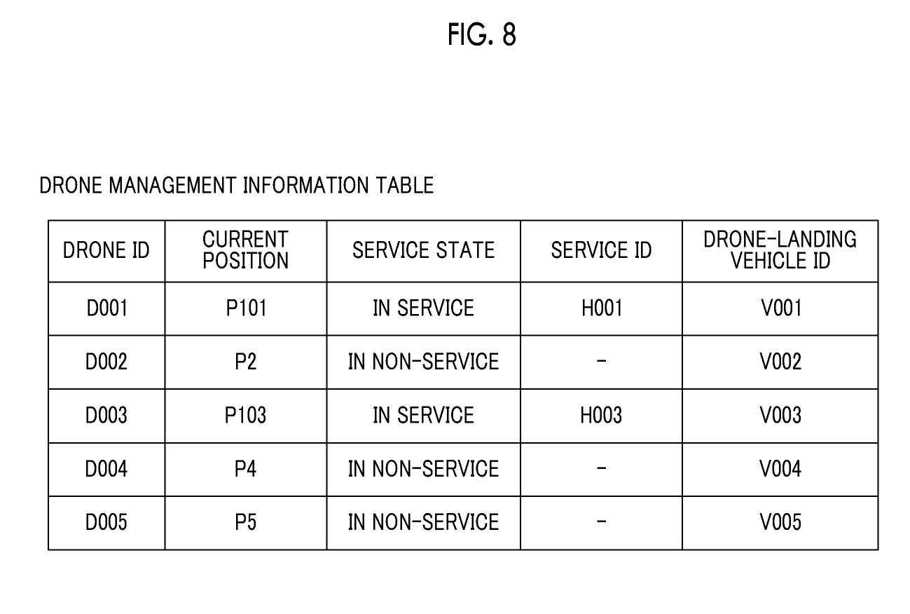

FIG. 8 shows an example of the drone management information table. The drone management information table is a table that is stored in the drone management DB 404 of the drone management server 400. In the drone management information table, information (drone management information) relating to the drone 200 is stored.

In the drone management information table, for example, fields of a drone ID, a current position, a service state, a service ID, and a drone-landing vehicle ID are included. In the field of the drone ID, the identification information of the drone 200 is input, the field of the current position, the positional information of the drone 200 is input. The field of the current position is updated each time the positional information is received from the drone 200 by the positional information management unit 401 of the drone management server 400.

In the field of the service state, any one of “IN SERVICE” and “IN NON-SERVICE” is input. An initial value of the field of the service state is “IN NON-SERVICE”. For example, when a flight command is transmitted to the drone 200 along with information related to a service, a value of the field of the service state is updated to “IN SERVICE”. When a service completion notification is received from the drone 200, the value of the field of the service state is updated to “IN NON-SERVICE”. The field of the service state is managed by the drone service state management unit 403 of the drone management server 400, for example.

In the field of the service ID, when the service state of the drone 200 is “IN SERVICE”, identification information of a service in execution is input. The identification information of the service is included in information relating to the service received from the center server 500 along with the use request of the drone 200. When the field of the service state is updated to “IN SERVICE”, the identification information of the service is input in the field of the service ID and the field of the service ID is updated. The field of the service ID is updated to blank when the field of the service state is updated to “IN NON-SERVICE”. The field of the service ID is managed by the drone service state management unit 403 of the drone management server 400, for example.

In the field of the drone-landing vehicle ID, the identification information of the vehicle 100 where the drone 200 lands is input. The drone 200 and the vehicle 100 exchange the identification information, for example, when the drone 200 lands on the landing field of the vehicle 100 and the power feed unit 1J of the vehicle 100 is connected to the power reception unit 2D of the drone 200. Thus, landing of the drone 200 on the vehicle 100 is detected. For example, the flight plan controller 201 of the drone 200 gives notification, to the drone management server 400 when landing on the vehicle 100 and take-off from the vehicle 100 are detected. The flight controller 402 of the drone management server 400 updates the field of the drone-landing vehicle ID in response to the notification from the drone 200.

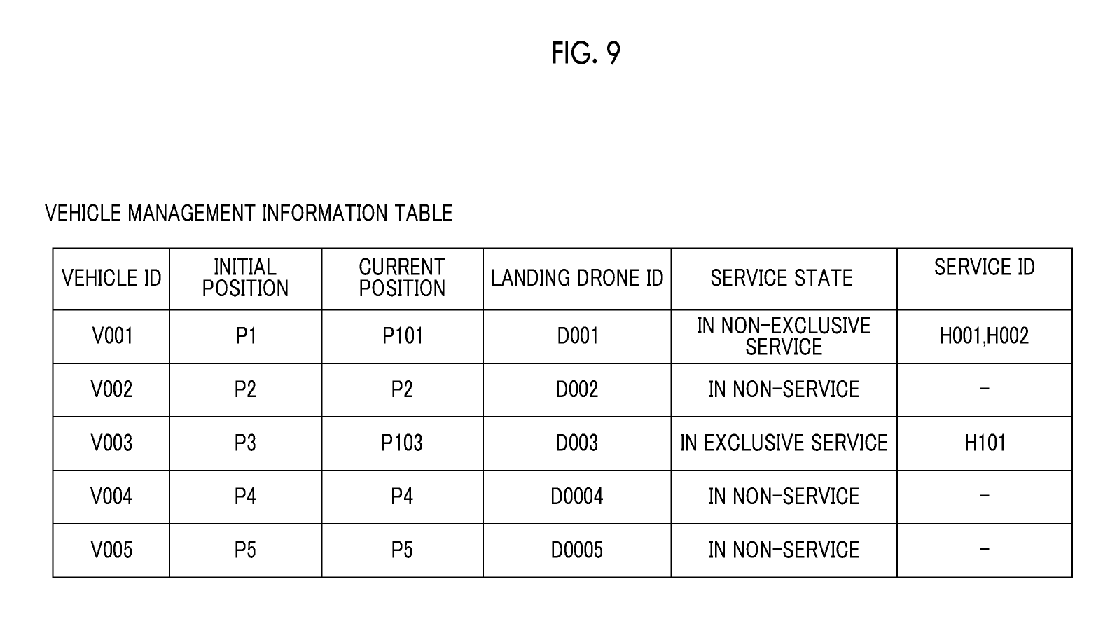

FIG. 9 shows an example of the vehicle management information table. The vehicle management information table is a table that is stored in the vehicle management DB 304 of the vehicle management server 300. In the vehicle management information table, information (vehicle management information) relating to the vehicle 100 is stored.

In the vehicle management information table, for example, a vehicle ID, an initial position, a current position, a landing drone ID, a service state, and a service ID are included. In the field of the vehicle ID, the identification information of the vehicle 100 is input. In the field of the initial position, positional information of an initial position of the vehicle 100 is input. When a service ends, the vehicle 100 is controlled to return to the initial position as long as there is no next service.

In the field of the current position, the positional information of the vehicle 100 is input. The field of the current position is updated each time the positional information is received from the vehicle 100 by the positional information management unit 301 of the vehicle management server 300.

In the field of the drone-landing vehicle ID, the identification information of the drone 200 that lands on the vehicle 100 is input. The operation plan controller 101 of the vehicle 100 gives notification to the vehicle management server 300 when landing of the drone 200 on the vehicle 100 or take-off of the drone 200 from the vehicle 100 is detected. The operation controller 302 of the vehicle management server 300 updates the field of the drone-landing vehicle ID in response to the notification from the vehicle 100.

In the field of the service state, any one of “IN EXCLUSIVE SERVICE”, “IN NON-EXCLUSIVE SERVICE”, and “IN NON-SERVICE” is input. Examples of a service that the vehicle 100 executes include an exclusive service that exclusively uses the vehicle 100 and a non-exclusive service that co-exists with a different service. Examples of the exclusive service include a service that carries the user to a predetermined position, or the like. Examples of the non-exclusive service include a delivery or pick-up service of a package, a service that makes the rounds of a predetermined route, or the like.

An initial value of the field of the service state is “IN NON-SERVICE”. When the vehicle 100 is executing an exclusive service or a non-exclusive service, the value of the field of the service state becomes “IN EXCLUSIVE SERVICE” or “IN NON-EXCLUSIVE SERVICE”. When a service completion notification is received from the vehicle 100 and the vehicle 100 is not executing a different service, the value of the field of the service state is updated to “IN NON-SERVICE”. The field of the service state is managed by the vehicle service state management unit 303 of the vehicle management server 300.

In the field of the service ID, when the vehicle 100 is in the service state of “IN EXCLUSIVE SERVICE” or “IN NON-EXCLUSIVE SERVICE”, identification information of a service in execution is input. The identification information of the service is received from the center server 500 along with the use request of the vehicle 100, for example. When the field of the service state is updated to “IN EXCLUSIVE SERVICE” or “IN NON-EXCLUSIVE SERVICE”, the identification information of the service is input in the field of the service ID and the field of the service ID is updated. When the field of the service state is “IN EXCLUSIVE SERVICE”, one service ID is input in the field of the service ID. When the field of the service state is “IN NON-EXCLUSIVE SERVICE”, one or a plurality of service IDs is input in the field of the service ID. The field of the service ID is updated to blank when the field of the service state is updated to “IN NON-SERVICE”. The field of the service ID is managed by the vehicle service state management unit 303 of the vehicle management server 300.

Flow of Processing

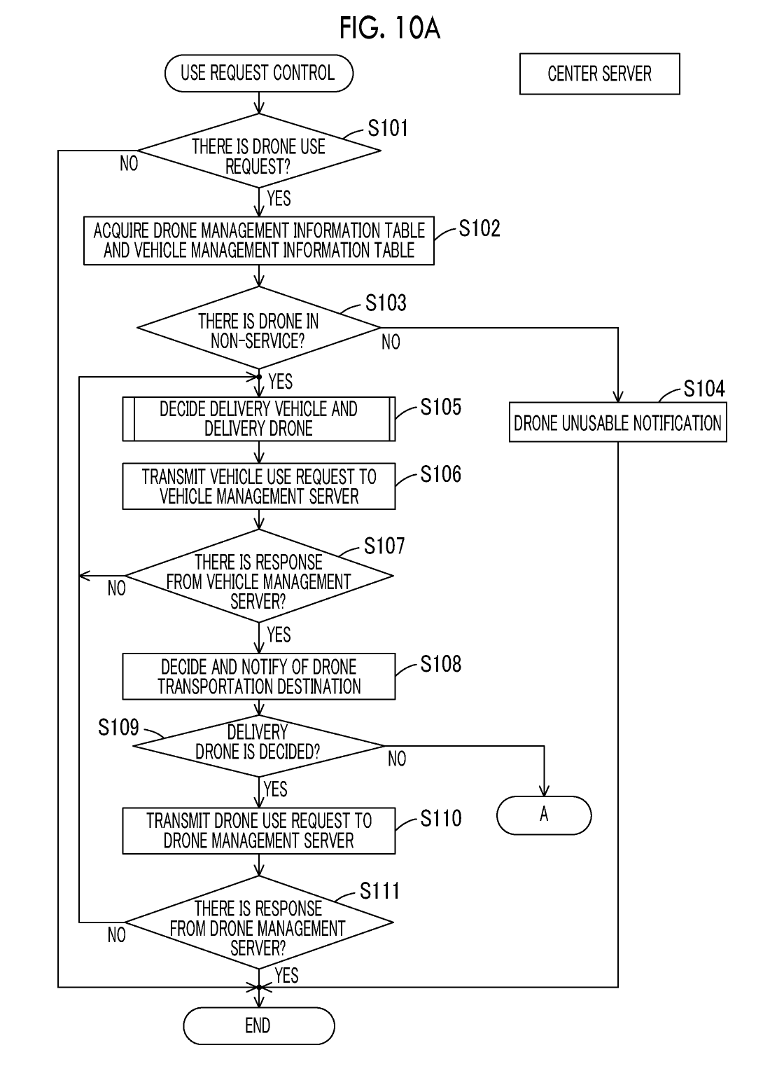

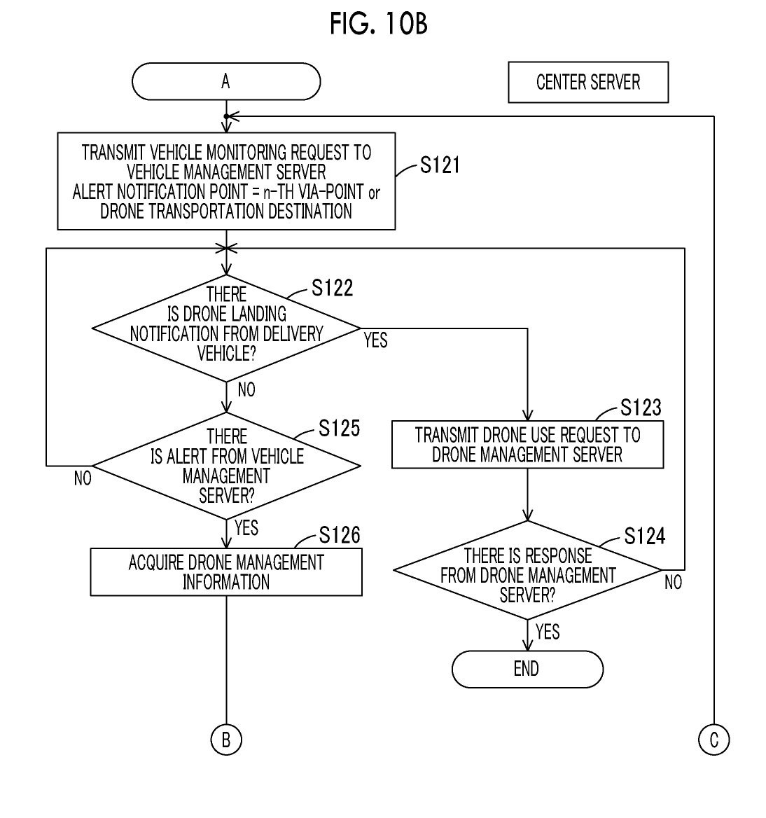

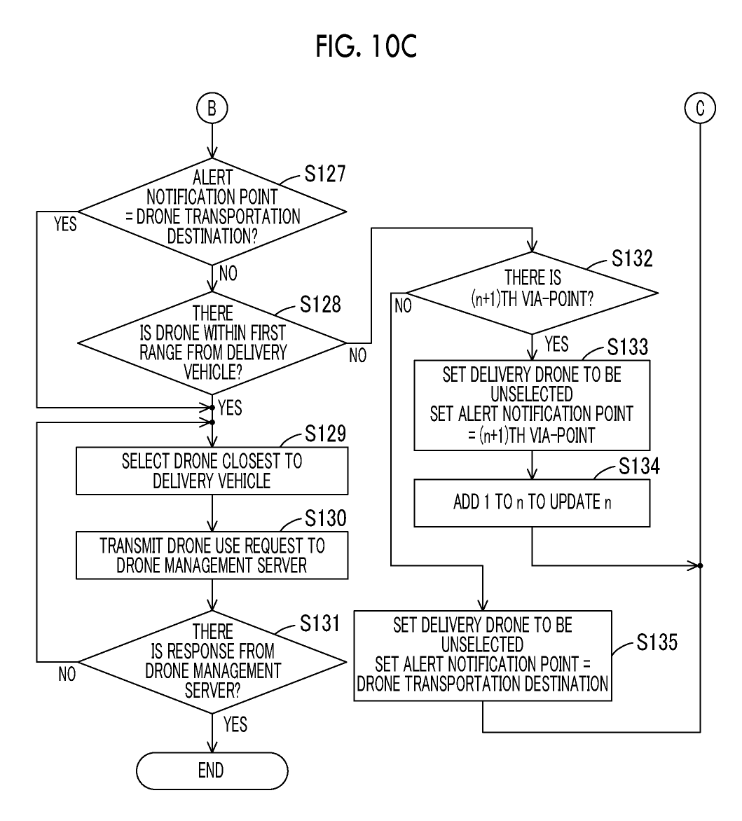

FIGS. 10A, 10B and 10C show an example of a flowchart of processing in the center server 500 when a request for a service using the drone 200 is received. The processing shown in FIGS. 10A, 10B and 10C is executed repeatedly in a predetermined cycle, for example. Although an execution subject of the processing shown in FIGS. 10A, 10B and 10C is the CPU 11, for convenience, description will be provided with the service controller 502 to be the functional constituent element as the subject. In the following flowcharts, similarly, description will be provided with the functional constituent element as the subject.

In S101, the service controller 502 determines whether or not the request for the service using the drone 200 is received by the request reception unit 501. When the request for the service using the drone 200 is received (S101: YES), the process progresses to S102. When the request for the service using the drone 200 is not received (S101: NO), the processing shown in FIG. 10A ends.

In S102, the service controller 502 acquires the drone management, information table from the drone management server 400 through the drone management information acquisition unit 503 and acquires the vehicle management information table from the vehicle management server 300 through the vehicle management information acquisition unit 504.

In S103, the service controller 502 determines whether or not there is the drone 200 that is in the service state of “IN NON-SERVICE” with reference to the acquired drone management information table. When there is the drone 200 that is in the service state of “IN NON-SERVICE” in the drone management information table (S103: YES), the process progresses to S105. When there is no drone 200 that is in the service state of “IN NON-SERVICE” in the drone management information table (S103: NO), the process progresses to S104. In S104, since there is no drone 200 that can be used in the requested service, the service controller 502 transmits a drone unusable notification to the request source. Thereafter, the processing shown in FIG. 10A ends.

In S105, the service controller 502 executes processing for deciding the delivery vehicle and the delivery drone based on the drone management information table and the vehicle management information table acquired in S102. Details of the decision processing of the delivery vehicle and the delivery drone will be described below. With the processing of S105, at least the delivery vehicle is decided. The delivery drone may be decided or undecided. When the delivery drone is undecided, any drone 200 does not land on the vehicle 100 selected as the delivery vehicle at the time of the end of S105.

In S106, the service controller 502 transmits a vehicle use request of the vehicle 100 selected as the delivery vehicle to the vehicle management server 300. In S107, the service controller 502 determines whether or not there is a response to the vehicle use request from the vehicle management server 300. For example, when the vehicle 100 selected as the delivery vehicle is usable, a response is received from the operation controller 302 of the vehicle management server 300. For example, when the vehicle 100 selected as the delivery vehicle is not usable because of executing a different exclusive service or the like, an unusable notification is received from the operation controller 302 of the vehicle management server 300. When there is a response to the vehicle use request from the vehicle management server 300 (S107: YES), the delivery vehicle is confirmed, and the process progresses to S108. When there is no response to the vehicle use request from the vehicle management server 300 (S107: NO), the process progresses to S105, and the decision processing of the delivery vehicle and the delivery drone is executed again.

In S108, since the delivery vehicle is confirmed, the service controller 502 decides the drone transportation destination on the requested service according to the service state of the vehicle 100 selected as the delivery vehicle. The service controller 502 notifies the vehicle management server 300 of information of the drone transportation destination. Subsequently, when the delivery vehicle is confirmed, the delivery vehicle is denoted as the delivery vehicle 100.

In the vehicle management information table acquired in S102, when the service state of the delivery vehicle 100 is “IN NON-SERVICE”, the service controller 502 sets a vehicle reachable limit point closest to the destination of the requested service as the drone transportation destination. For example, when the requested service is a delivery service of a package and the delivery destination (destination) is a seventh floor of an apartment, the drone transportation destination (vehicle reachable limit point) becomes an address of the apartment.

In the vehicle management information table acquired in S102, when the service state of the delivery vehicle 100 is “IN NON-EXCLUSIVE SERVICE”, the service controller 502 sets, as the drone transportation destination, a point closest to the destination on a route in a non-exclusive service that the delivery vehicle 100 is executing. With this, it is possible to make a flight distance of the delivery drone from the delivery vehicle 100 to the destination as short as possible.

When the delivery vehicle is confirmed, the service controller 502 registers information of the service in the service management information table. Specifically, the identification information of the service is input in the service ID, the identification information of the vehicle 100 selected as the delivery vehicle is input in the delivery vehicle ID, and “IN SERVICE” is input in the service state.

In S109, the service controller 502 determines whether or not the delivery drone is undecided. When the delivery drone is undecided (S109: YES), the process progresses to S121 of FIG. 10B. When the delivery drone is decided (S109: NO), the process progresses to S110.

In S110, the service controller 502 transmits a drone use request on the drone 200 selected as the delivery drone to the drone management server 400. In S111, the service controller 502 determines whether or not there is a response to the drone use request from the drone management server 400. For example, when the drone 200 selected as the delivery drone is usable, a response is received from the flight controller 402 of the drone management server 400. For example, when the drone 200 selected as the delivery drone is not usable because of executing a different service or the like, an unusable notification is received from the operation controller 302 of the drone management server 400.

When there is a response to the drone use request from the drone management server 400 (S111: YES), the delivery drone is confirmed, and the service controller 502 registers the delivery drone in the service management information table. Thereafter, the processing shown in FIG. 10A ends. When there is no response to the drone use request from the drone management server 400 (S111: NO), the drone remains undecided, the process progresses to S105, and the decision processing of the delivery vehicle and the delivery drone is executed again.

In S121 of FIG. 10B, the service controller 502 transmits a vehicle monitoring request on the delivery vehicle 100 to the vehicle management server 300. The vehicle monitoring request is a request for notification of an alert when the vehicle 100 enters within a predetermined range from an alert notification point. The predetermined range from the alert notification point is, for example, a range of 100 m to 1 km from the alert notification point. The alert notification point is an n-th via-point or the drone transportation destination. Whether the alert notification point is the n-th via-point or the drone transportation destination is different depending on the type of the service, the presence or absence of a via-point, or the like, and is decided in the decision processing of the delivery vehicle and the delivery drone described below. An initial value of n is 1.

In S122, the service controller 502 determines whether or not a drone landing notification is received from the delivery vehicle 100 through the vehicle management server 300. In the first embodiment, normally, the drone landing notification from the vehicle 100 is not transferred from the vehicle management server 300 to the center server 500; however, while the vehicle management server 300 is receiving the vehicle monitoring request, the drone landing notification from the vehicle 100 is transferred from the vehicle management server 300 to the center server 500. The vehicle management server 300 notifies the center server 500 of an alert, whereby the vehicle monitoring request is cancelled.

When the drone landing notification is received from the delivery vehicle 100 through the vehicle management server 300 (S122: YES), indication is made that the drone 200 lands during movement of the delivery vehicle 100, and in order to determine whether or riot the drone 200 is usable as the delivery drone, the process progresses to S123.

In S123 and S124, similarly to S110 and S111, the service controller 502 transmits the drone use request on the drone 200 selected as the delivery drone to the drone management server 400 (S123), and checks the presence or absence of a response (S124). When there is a response to the vehicle use request from the drone management server 400 (S124: YES), the delivery drone is confirmed as the drone 200 that newly lands on the delivery vehicle, and the service controller 502 registers the delivery drone 200 in the service management information table. Thereafter, the processing shown in FIG. 10B ends. When there is no response to the vehicle use request from the drone management server 400 (S124: NO), the drone remains undecided, and the process progresses to S122.

In S125, the service controller 502 determines whether or not there is an alert from the vehicle management server 300. When there is an alert from the vehicle management server 300 (S125: YES), that is, when the delivery vehicle 100 enters within the predetermined range from the alert notification point, the process progresses to S126. When there is no alert from the vehicle management server 300 (S125: NO), the process progresses to S122.

In S126, the service controller 502 acquires the drone management information table from the drone management server 400 through the drone management information acquisition unit 503. In S127, the service controller 502 determines whether or not the alert notification point is the drone transportation destination. When the alert notification point is the drone transportation destination (S127: YES), the process progresses to S129. When the alert notification point is not the drone transportation destination, that is, when the alert notification point is the n-th via-point (S127: NO), the process progresses to S128.

In S128, the service controller 502 determines whether or not there is the drone 200 within a first range from the delivery vehicle 100. The first range is, for example, a range in which the BLE signal transmitted from the delivery vehicle 100 is detectable. The positional information of the delivery vehicle 100 is received from the vehicle management server 300 along with the alert, for example. The positional information of the drone 200 is acquired from the drone management information table acquired in S126. When there is the drone 200 within the first range from the delivery vehicle 100 (S128: YES), the process progresses to S129. When there is no drone 200 within the first range from the delivery vehicle 100 (S128: NO), the process progresses to S132. The first range is an example of a “second range”.

In S129, the service controller 502 selects the drone 200 closest to the delivery vehicle as the delivery drone. In S130 and S131, similarly to S110 and S111, the service controller 502 transmits the drone use request on the drone 200 selected as the delivery drone to the drone management server 400 (S130), and checks the presence or absence of a response (S131). When there is a response to the drone use request from the drone management server 400 (S131: YES), the delivery drone is confirmed, as the drone 200 that newly lands on the delivery vehicle, and the service controller 502 registers the delivery drone 200 in the service management information table. Thereafter, the processing shown in FIG. 10C ends. When there is no response to the drone use request from the drone management server 400 (S131: NO), the process progresses to S129, and in S129, the drone 200 next closest to the delivery vehicle 100 is selected as the delivery drone.

In S132, the service controller 502 determines whether or not there is an (n+1)th via-point. When there is the (n+1)th via-point (S132: YES), the process progresses to S133. When there is no (n+1)th via-point (S132: NO), the process progresses to S135.

In S133, the service controller 502 sets the delivery drone to be unselected and sets the alert notification point as the (n+1)th via-point. In S134, the service controller 502 adds 1 to n to update n. Thereafter, the process progresses to S121.

In S135, the delivery drone is set to be unselected, and the alert notification point is set as the drone transportation destination. Thereafter, the process progresses to S121.

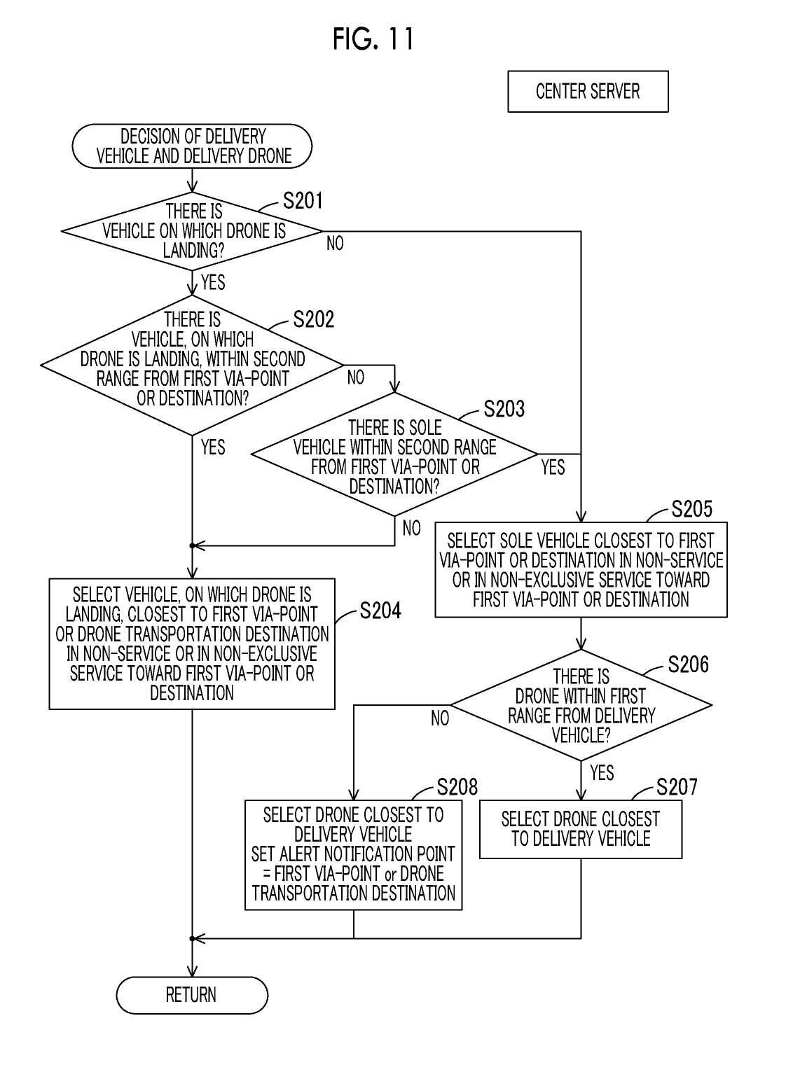

FIG. 11 shows an example of a flowchart of the decision processing of the delivery vehicle and the delivery drone in the center server 500. The processing shown in FIG. 11 is processing that is executed in S105 of FIG. 10A.

In S201, the service controller 502 determines whether or not there is the vehicle 100 where the drone 200 lands based on the vehicle management information table acquired in S102 of FIG. 10A, for example. When there is the vehicle 100 where the drone 200 lands (S201: YES), the process progresses to S202. When there is no vehicle 100 where the drone 200 lands (S201: NO), the process progresses to S205.

In S202, the service controller 502 determines whether or not there is the vehicle 100 where the drone lands within a second range from a first via-point or the destination. The second range is, for example, a range wider than the first range. In S202, whether the first via-point or the destination is used is decided depending on the presence or absence of a via-point. For example, in a case of a delivery service of a package, a pick-up place (for example, a collection and delivery center or the like) of the package is set as the first via-point, and a delivery destination of the package is set as the destination. For example, in a case of a rental service of a drone, a via-point is not set, and a rental destination of a drone is set as the destination. The second range is an example of a “first range”.

When there is the vehicle 100 where the drone lands within the second range from the first via-point or the destination (S202: YES), the process progresses to S204. When there is no vehicle 100 where the drone lands within the second range from the first via-point or the destination (S202: NO), the process progresses to S203.

In S203, the service controller 502 determines whether or not there is the vehicle 100 where the drone does not land within the second range from the first via-point or the destination. Hereinafter, the vehicle 100 where the drone does not land is referred to as a “sole vehicle”. When there is a sole vehicle within the second range from the first via-point or the destination (S203: YES), the process progresses to S205. When there is no sole vehicle within the second range from the first via-point or the destination (S203: NO), the process progresses to S204.

In S204, the service controller 502 selects, as the delivery vehicle, the vehicle 100 that is in non-service or is in non-exclusive service and goes the first via-point or the destination, and is closest to the first via-point or the destination, from among the vehicles 100 where the drones land. The vehicle 10 0 that is in nonexclusive service and goes toward the first via-point or the destination can be specified based on the service management information table and the vehicle management information table acquired from the vehicle management server 300, for example. Thereafter, the processing shown in FIG. 11 ends, and the process progresses to S106 of FIG. 10A.

In S205, the service controller 502 selects, as the delivery vehicle, the vehicle 100 that is in non-service or in non-exclusive service and goes toward the first via-point or the destination, and is closest to the first via-point or the destination, from among the sole vehicles.

In S206, the service controller 502 determines whether or not there is the drone 200 within the first range from the vehicle 100 selected as the delivery vehicle. When there is the drone 200 within the first range from the vehicle 100 selected as the delivery vehicle (S206: YES), the process progresses to S207. When there is no drone 200 within the first range from the vehicle 100 selected as the delivery vehicle (S206: NO), the process progresses to S208.

In S207, the service controller 502 selects, as the delivery drone, the drone 200 closest to the vehicle 100 selected as the delivery vehicle. Thereafter, the processing shown in FIG. 11 ends, and the process progresses to S106 of FIG. 10A.

In S208, the service controller 502 sets the delivery drone to be unselected and sets the alert notification point as the first via-point or the drone transportation destination. When there is a via-point, the alert notification point is set as the first via-point. When there is no via-point, the alert notification point is set as the drone transportation destination. The drone transportation destination is not decided at this time. Thereafter, the processing shown in FIG. 11 ends, and the process progresses to S106 of FIG. 10A.

According to the processing shown in FIGS. 10A, 10B, 10C, and 11, the vehicle 100 where the drone lands and the drone 200 are selected with priority as the delivery vehicle and the delivery drone that execute the service (FIG. 11, a case of S202: YES). When there is a sole vehicle closer to the first, via-point or the destination than the vehicle 100 where the drone lands, since the sole vehicle is highly likely to arrive at the first via-point or the destination earlier than the vehicle 100 where the drone lands, the sole vehicle is selected as the delivery vehicle (FIG. 11, a case of S203: YES).

When the delivery drone remains undecided while the sole vehicle is selected as the delivery vehicle, a candidate point (the first via-point or the drone transportation destination) of a joining point of the sole vehicle and the drone 200 is set as the alert notification point. The center server 500 detects that the delivery vehicle enters within the predetermined range from the alert notification point with the alert, and selects the drone 200 near the delivery vehicle as the delivery drone (FIG. 10C). With this, the delivery vehicle can, join the drone 200 before arrival at the drone transportation destination.

In the processing shown in FIGS. 10A, 10B, 10C, and 11, since the drone transportation destination is set to a position as close as possible to the destination according to the service state of the delivery vehicle (FIG. 10A, S108), it is possible to reduce the flight distance of the drone 200 as much as possible. The vehicle 100 where the drone lands is selected as the delivery vehicle with priority (FIG. 11, S202), or a sole vehicle within the second range from the first via-point is selected as the delivery vehicle and the drone 200 closest to the delivery vehicle is selected as the delivery drone such that the drone 200 and the vehicle 100 join each other as early as possible (FIGS. 11, S205 to S207), whereby it is possible to reduce the flight distance of the drone 200 as much as possible.

In the processing shown in FIGS. 10A, 10B, 10C, and 11, for example, when there is no drone 200 near the first via-point and within the first range from the delivery vehicle, the delivery drone remains undecided, and each time the delivery vehicle approaches a via-point subsequent to the first via-point or the destination, the drone 200 within the first range is searched based on, the position of the delivery vehicle at this time. With this, it is possible to further reduce a time for which the delivery vehicle is waiting for landing of the drone 200.

In S129 of FIG. 10C and S207 of FIG. 11, although the drone 200 closest to the vehicle 100 selected as the delivery vehicle is selected as the delivery drone, a selection method of the delivery drone 200 is not limited thereto. For example, any one of the drones 200 within a predetermined range from the vehicle 100 selected from the delivery vehicle may be selected as the delivery drone.

In S205 of FIG. 1 1, although the vehicle 100 closest to the first via-point or the destination is selected as the delivery vehicle, a selection method of the delivery vehicle is not limited thereto. For example, any one of a vehicle where a drone lands and a sole vehicle within a predetermined range from the first via-point or the destination may be selected as the delivery vehicle.

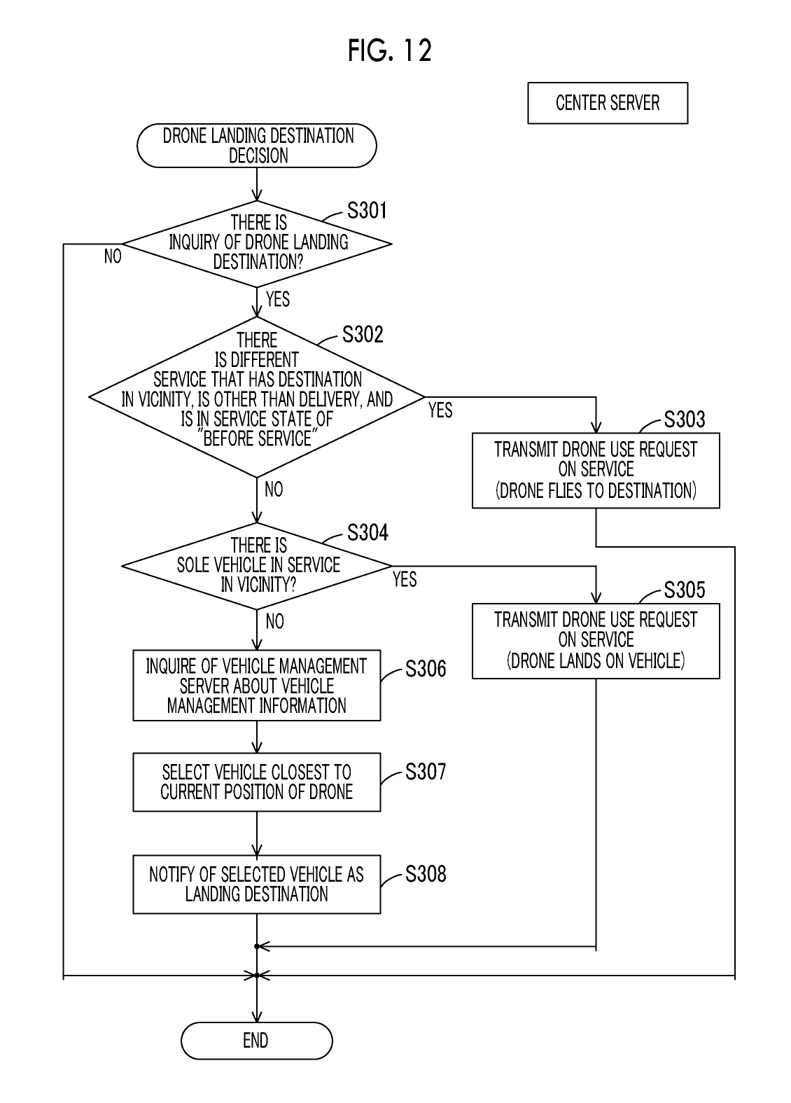

FIG. 12 shows an example of a flowchart of drone landing destination decision processing in the center server 500. The processing shown in FIG. 12 is executed repeatedly in a predetermined cycle, for example.

In S301, the service controller 502 determines whether or not an inquiry of a landing destination of a drone is received. The inquiry of the landing destination of the drone is received from the drone 200 through the drone management server 400, for example. The drone 200 transmits the inquiry of the landing destination of the drone, for example, when execution of predetermined processing ends at the destination of the service. The positional information of the drone 200 as an inquiry source is also received along with the inquiry of the landing destination of the drone. When the inquiry of the landing destination of the drone is received (S301: YES), the process progresses to S302. When the inquiry of the landing destination of the drone is not received (S301: NO), the processing shown in FIG. 12 ends.

In S302, the service controller 502 determines whether or not there is a different service that has the destination in the vicinity of the drone 200, is other than delivery, and is in the service state of “BEFORE SERVICE” with reference to the service management information table. The vicinity of the drone 200 is, for example, a predetermined range (for example, tens of meters) from the current position of the drone 200. The determination processing is processing that is intended to send the drone 200 to the destination directly without transportation with the vehicle 100 when there is a destination of a different service using the drone 200 in the vicinity of the drone 200 as the inquiry source. However, in a case of a delivery service, since a package needs to be loaded on the drone 200, the drone 200 cannot be delivered directly to the destination, and thus, the delivery service is excluded.

When there is the corresponding service (S302: YES), the process progresses to S303. When there is no corresponding service (S302: NO), the process progresses to S304. In S303, the service controller 502 selects the drone 200 as the inquiry source as the delivery drone of the service and transmits the drone use request on the service to the drone management server 400. The drone management server 400 performs a response to the drone use request for the center server 500 and transmits the flight command to the destination of the service as a response to the inquiry of the landing destination of the drone to the drone 200. Thereafter, the processing shown in FIG. 12 ends.

In S304, the service controller 502 determines whether or not there is a sole vehicle that is in the vicinity of the drone 200 as the inquiry source and is in the service state of “IN SERVICE”. The processing of S304 is processing for determining whether or not there is the vehicle 100 that needs the drone 200 in the vicinity of the drone 200 as the inquiry source. When there is a sole vehicle that is in the vicinity of the drone 200 as the inquiry source and is in the service state of “IN SERVICE” (S304: YES), the process progresses to S305. When there is no sole vehicle in service in the vicinity of the drone 200 as the inquiry source (S304: NO), the process progresses to S306.

In S305, the service controller 502 selects the drone 200 as the inquiry source as the delivery drone on the service that the sole vehicle in the vicinity of the drone 200 as the inquiry source and in the service state of “IN SERVICE” and transmits the drone use request on the service to the drone management server 400. Information relating to the service that the sole vehicle executes is also transmitted along with the drone use request. The drone management server 400 performs a response to the drone use request for the center server 500 and transmits the flight command to the delivery vehicle of the service as a response to the inquiry of the landing destination of the drone to the drone 200. Thereafter, the processing shown in FIG. 12 ends.

In S306, the service controller 502 inquires of the vehicle management server 300 to acquire the vehicle management information table. In S307, a vehicle closest to the current position of the drone 200 as an inquiry source is selected as the landing destination of the drone 200. In S308, the service controller 502 notifies the drone management server 400 of the vehicle selected in S307 as the landing destination of the drone 200 as a response to the inquiry of the landing destination of the drone. The drone management server 400 transmits the flight command to the vehicle 100 notified as the landing destination of the drone 200 to the drone 200 as a response to the inquiry of the landing destination of the drone. Thereafter, the processing shown in FIG. 12 ends.

The drone landing destination decision processing shown in FIG. 12 is an example, and a selection method of the vehicle 100 to be the landing destination of the drone 200 is not limited to the example shown in FIG. 12. For example, in S307, the service controller 502 selects, as the landing destination, the vehicle 100 closest to the drone 200 as the inquiry source from among, the vehicles 100 that are in non-service and goes toward the initial position.

### SPECIFIC EXAMPLES

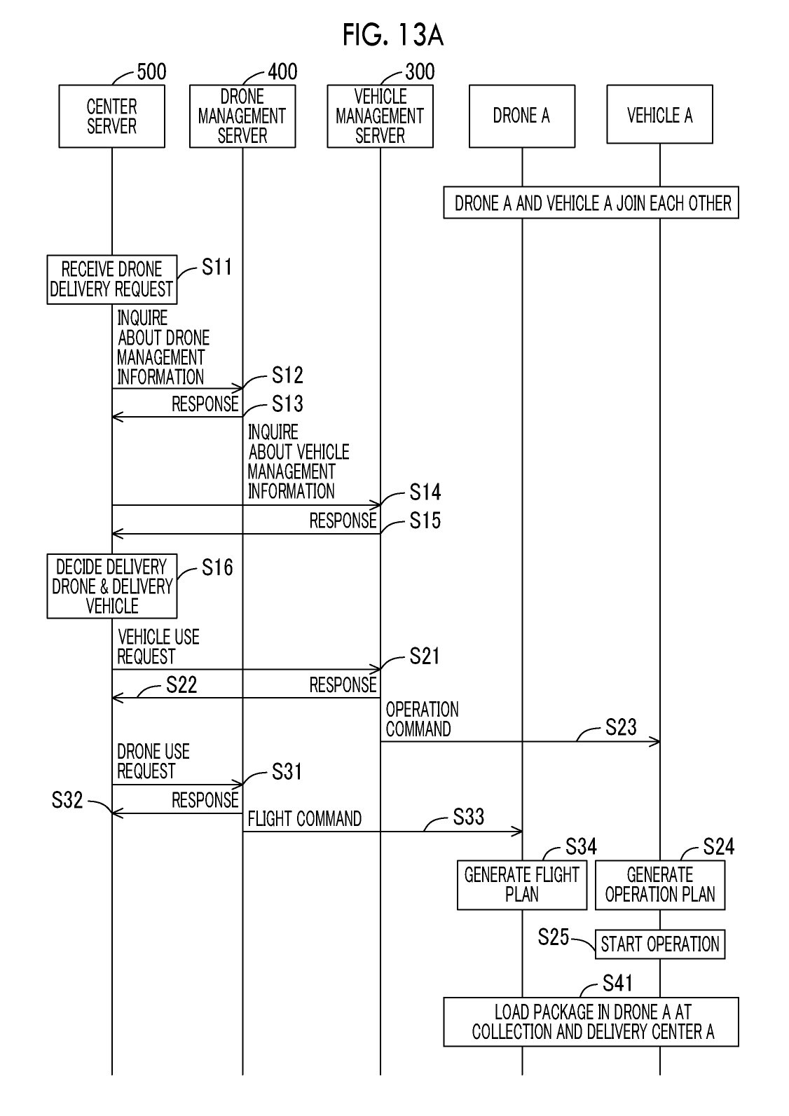

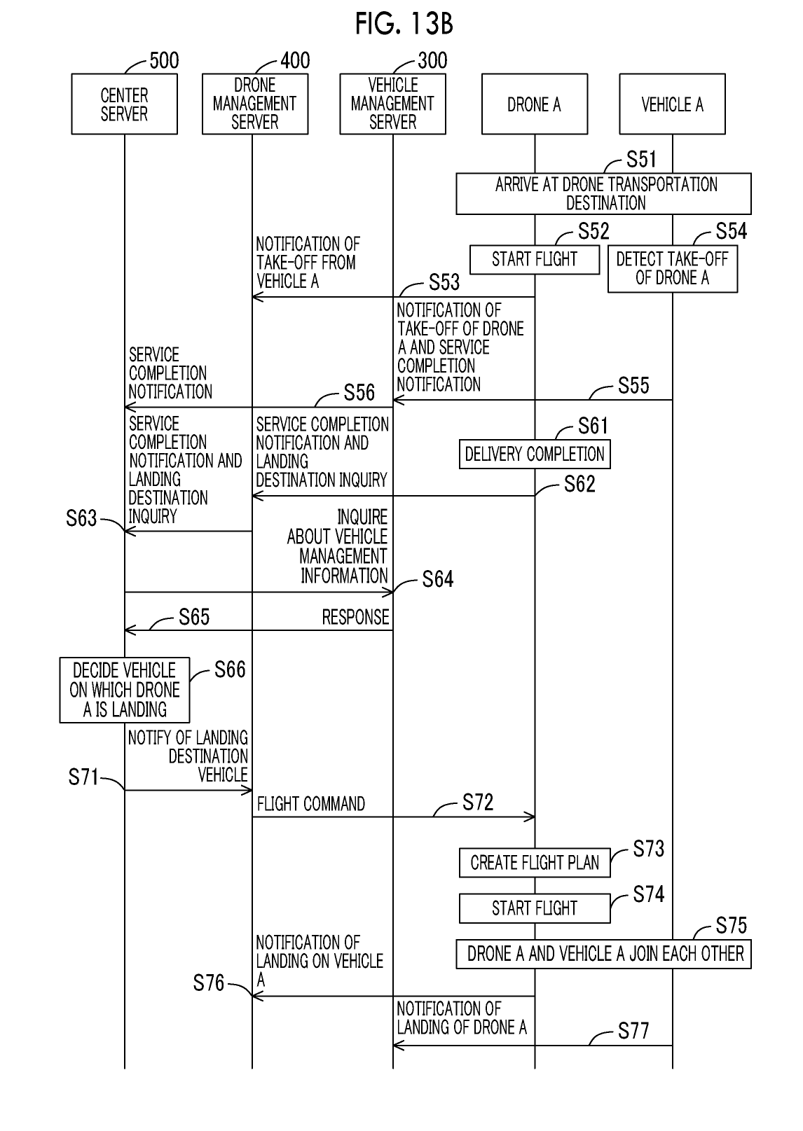

FIGS. 13A and 13B are diagrams showing an example of a processing sequence in Specific Example 1. Specific Example 1 is an example of a case where a request for a delivery service of a package is received. In Specific Example 1, an example where a drone A and a vehicle A where the drone A lands are selected as the delivery drone and the delivery vehicle, respectively, and the drone A lands on the vehicle A again after delivery completion will be described. That is, in Specific Example 1, it is a premise that the drone A lands on the vehicle A. It is also assumed that both of the drone A and the vehicle A are in non-service.

In S11, the center server 500 receives a request for a delivery service of a package with a drone (FIG. 10A, S101: YES). In the delivery service, it is assumed that a collection and delivery center A is designated as a pick-up place. Accordingly, in Specific Example 1, the first via-point becomes the collection and delivery center A as a pick-up place in the delivery service, and the destination becomes a delivery destination.

In S12, the center server 500 performs an inquiry of the drone management information table to the drone management server 400. In S13, the drone management server 400 transmits the drone management information table to the center server 500 as a response to the inquiry from the center server 500, and the center server 500 acquires the drone management information table (FIG. 10A, S102).

In S14, the center server 500 performs an inquiry of the vehicle management information table to the vehicle management server 300. In S15, the vehicle management server 300 transmits the vehicle management information table to the center server 500 as a response to the inquiry from the center server 500, and the center server 500 acquires the vehicle management information table (FIG. 10A, S102).

In Specific Example 1, it is assumed that the vehicle A where the drone A lands is within the second range from the collection and delivery center A as the first via-point, and the different vehicle 100 where the drone 200 lands is not within the second range. Accordingly, in S16, the center server 500 decides the vehicle A “IN NON-SERVICE” as the delivery vehicle, and decides the drone A “IN NON-SERVICE” as the delivery drone (FIG. 10A, S105, FIG. 11, S202: YES, S204).

In S21, the center server 500 transmits a vehicle use request on the vehicle A to the vehicle management server 300 (FIG. 10A, S106). As information relating to the service to be transmitted along with the vehicle use request, for example, positional information of the collection and delivery center A as the first via-point, positional information of the delivery destination as the destination, identification information of a delivery package, and the like are also transmitted.

In S22, since the vehicle A is “IN NON-SERVICE” and is usable, the vehicle management server 300 transmits a response to the vehicle use request on the vehicle A. When the center server 500 receives the response from the vehicle management server 300 (FIG. 10A, S107: YES), the delivery vehicle is confirmed to the vehicle A, and the center server 500 decides the drone transportation destination as the vehicle reachable limit point closest to the delivery destination of the package and notifies the vehicle management server 300 of the drone transportation destination (FIG. 10A, S108) (not shown in FIG. 13A). For example, when the delivery destination is room 702 of an apartment A, the destination becomes the room 702 of the apartment A, and the drone transportation destination becomes before a front door (vehicle reachable limit point) of the apartment A.

In S23, the vehicle management server 300 transmits an operation command to the vehicle A. The operation command to be transmitted to the vehicle A includes, for example, the collection arid delivery center A as the via-point, the drone transportation destination as the destination, and loading the package at the collection and delivery center A.

In S24, the vehicle A receives the operation command from the vehicle management server 300 and generates an operation plan based on the operation command. The operation plan generated in S24 includes, for example, data relating to an operation route from the current position to the collection and delivery center A as the first via-point, loading the package at the collection and delivery center A, and data relating to an operation route from the collection and delivery center A as the first via-point to the drone transportation destination. In S25, the vehicle A starts an operation to the collection and delivery center A as the first via-point based on the operation plan.

In S31, the center server 500 transmits a drone use request on the drone A to the drone management server 400 (FIG. 10A, S110). In this case, as information relating to the service to be transmitted along with the drone use request, for example, the positional information of the collection and delivery center A as the first via-point, positional information of the vehicle reachable limit point to the delivery destination as the drone transportation destination (take-off position), the positional information, of the delivery destination as the destination, the identification information of the delivery package, and the like are also transmitted.

In S32, since the drone A is “IN NON-SERVICE” and is usable, the drone management server 400 transmits a response to the drone use request on the drone A. When the center server 500 receives the response from the drone management server 400 (FIG. 10A, S111: YES), the delivery drone is confirmed to the drone A, and the drone A is registered as the delivery drone of the service in the service management information table.

In S33, the drone management server 400 transmits a flight command to the drone A. The flight command to be transmitted to the drone A includes, for example, information relating to the service, a command for take-off at the drone transportation destination, a command for transportation of the package to the destination, and the like.

In S34, the drone A receives the flight command from the drone management server 400 and generates a flight plan based on the flight command. The flight plan generated in S34 includes, for example, loading the package, taking off at the drone transportation destination (take-off point), a flight route to the delivery destination (destination), unloading the package at the delivery destination, and the like.

In S41, the vehicle A where the drone A lands arrives at the collection and delivery center A, and the package is loaded on the drone A. Loading of the package on the drone A may be performed by an attendant of the collection and delivery center A or may be automatically performed without manual operation when the vehicle A and the drone A include a mechanism for loading a package on the drone 200.

In S51 of FIG. 13B, the vehicle A where the drone A lands arrives at the vehicle reachable limit point to the delivery destination as the drone transportation destination. In S52, the drone A detects arrival at the drone transportation destination from the positional information of the drone A and starts a flight to the destination (delivery destination) according to the flight plan. In S53, the drone A transmits a notification of take-off from the vehicle A to the drone management server 400. The drone A detects take-off from the vehicle A by detecting cutoff of connection for power feed to the vehicle A, for example. When the notification of take-off from the vehicle A is received from the drone A, the drone management server 400 deletes the identification information of the vehicle A from the field of the drone-landing vehicle ID of the drone A of the drone management information table and updates the field of the drone-landing vehicle ID to blank, for example.

In S54, the vehicle A detects that the drone A takes off. The vehicle A detects that the drone A takes off from the host vehicle by detecting cutoff of connection for power feed to the vehicle A.

In S55, the vehicle A transmits a notification of take-off of the drone A to the vehicle management server 300. When the notification of take-off of the drone A is received from the vehicle A, for example, the vehicle management server 300 deletes the identification information of the drone A from the field of the landing drone ID of the vehicle A of the vehicle management information table, for example.

For example, when the vehicle A detects arrival at the drone transportation destination from the positional information of the host vehicle, the vehicle A detects that the operation plan ends and detects service completion by detecting that the operation plan ends. Accordingly, in S55, the vehicle A also transmits a service completion notification to the vehicle management server 300 in addition to the notification of take-off of the drone A. When the service completion notification is received from the vehicle A, and for example, when the vehicle A is not executing a different service, the vehicle management server 300 updates the service state of the vehicle A in the vehicle management information table to “IN NON-SERVICE”. Alternatively, the vehicle management server 300 may transmit an operation command indicating movement to the initial position to the vehicle A to allow the vehicle A to return to the initial position.

In S56, the vehicle management server 300 transfers the service completion notification from the vehicle A to the center server 500. Since the center server 500 holds the service completion notification from the vehicle A, but does not receive the service completion notification from the drone A as the delivery drone, the service management information table is not updated at this time.

In S61, the drone A completes delivery of the package, and accordingly, the service of the drone A is completed. The drone A detects the completion of the service by receiving an input of a completion notification from an addressee on a touch panel in the drone A or a notification of completion of the delivery service from a user terminal of the addressee to a predetermined server through the center server 500 and the drone management server 400, for example.

In S62, the drone A transmits the service completion notification and the inquiry of the landing destination to the drone management server 400. The positional information of the drone A is also transmitted along with the inquiry of the landing, destination. When the service completion notification is received from the drone A, the drone management server 400 updates the service state of the drone A in the drone management information table to “IN NON-SERVICE”.

In S63, the drone management server 400 transfers the service completion notification and the inquiry of the landing destination from the drone A to the center server 500. When the service completion notification from the drone A is received, since the service completion notifications are received from the vehicle. A as the delivery vehicle and the drone A as the delivery drone, the center server 500 updates the service state of the service in the service management information table to “SERVICE COMPLETION”.

In S64, since the inquiry of the landing destination from the drone A is received (FIG. 12, S301: YES), and there is no service that has the destination in the vicinity of the drone A and there is no vehicle 100 before a service that needs the drone 200 (FIG. 12, S302: NO, S304: NO), the center server 500 inquires of the vehicle management server 300 about the vehicle management information table (FIG. 12, S306). In S65, the vehicle management server 300 transmits the vehicle management information table to the center server 500 as a response.

In S66, the center server 500 selects the vehicle A as the vehicle 100 closest to the drone A based on the positional information of the drone A and the positional information of each vehicle 100 included in the vehicle management information table (FIG. 12, S307).

In S71, the center server 500 notifies the drone management server 400 of the vehicle A as the landing destination as a response to the inquiry of the landing destination of the drone A. In S72, the drone management server 400 transmits a flight command including a command for landing on the vehicle A to the drone A as a response to the inquiry of the landing destination. In S71, the center server 500 may transmit the positional information of the vehicle A to the drone management server 400, and in S72, the drone management server 400 may transmit the positional information at the vehicle A to the drone A.

In S73, the drone A generates a flight plan to the vehicle A. In S74, the drone A starts a flight toward the vehicle A. When the drone A is within a range in which the BLE signal from the vehicle A is receivable, the drone A may fly toward the vehicle A detected from the BLE signal, or when the positional information of the vehicle A is received from the center server 500 through the drone management server 400, the drone A may fly with the positional information of the vehicle A as the destination.

In S75, the drone A lands on the landing field of the vehicle A and joins the vehicle A. The vehicle A and the drone A detects landing of the drone A on the vehicle A by detecting that the drone A lands on the landing field and the power reception unit 2D of the drone. A is connected to the power feed unit 13 of the vehicle A, for example.

In S76, the drone A transmits a notification of landing on the vehicle A to the drone management server 400. In S77, the vehicle A transmits a notification of landing of the drone A to the vehicle management server 300.

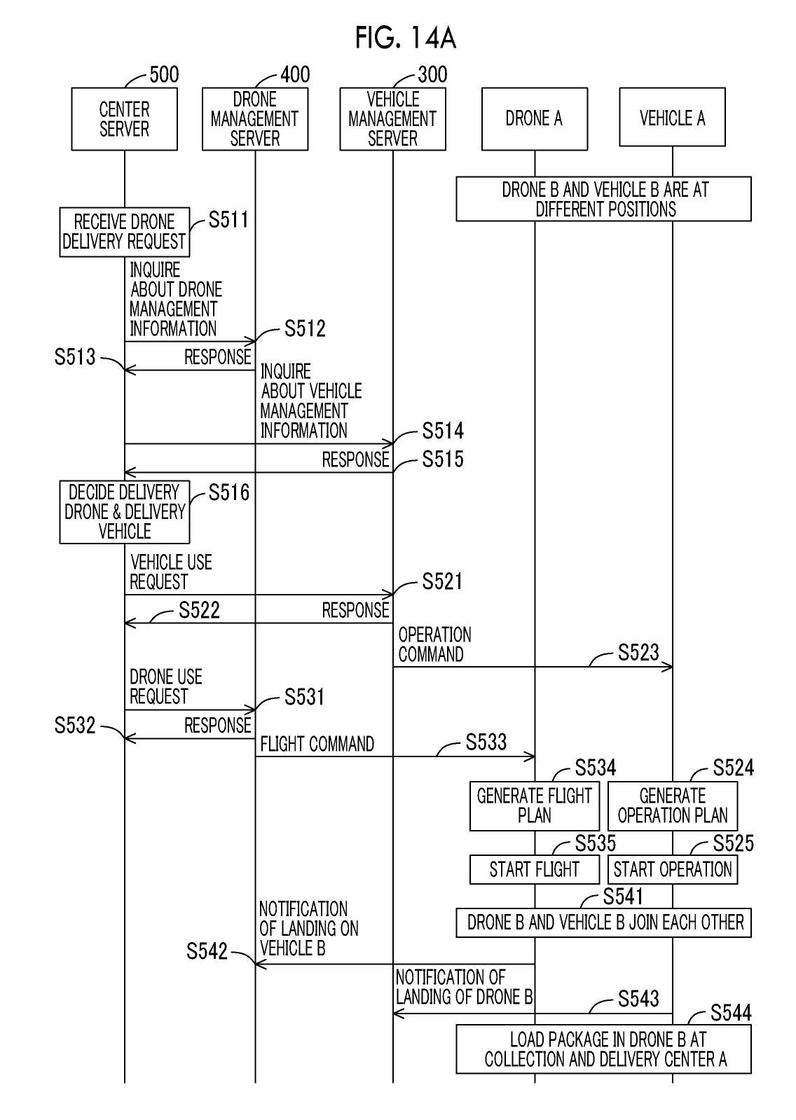

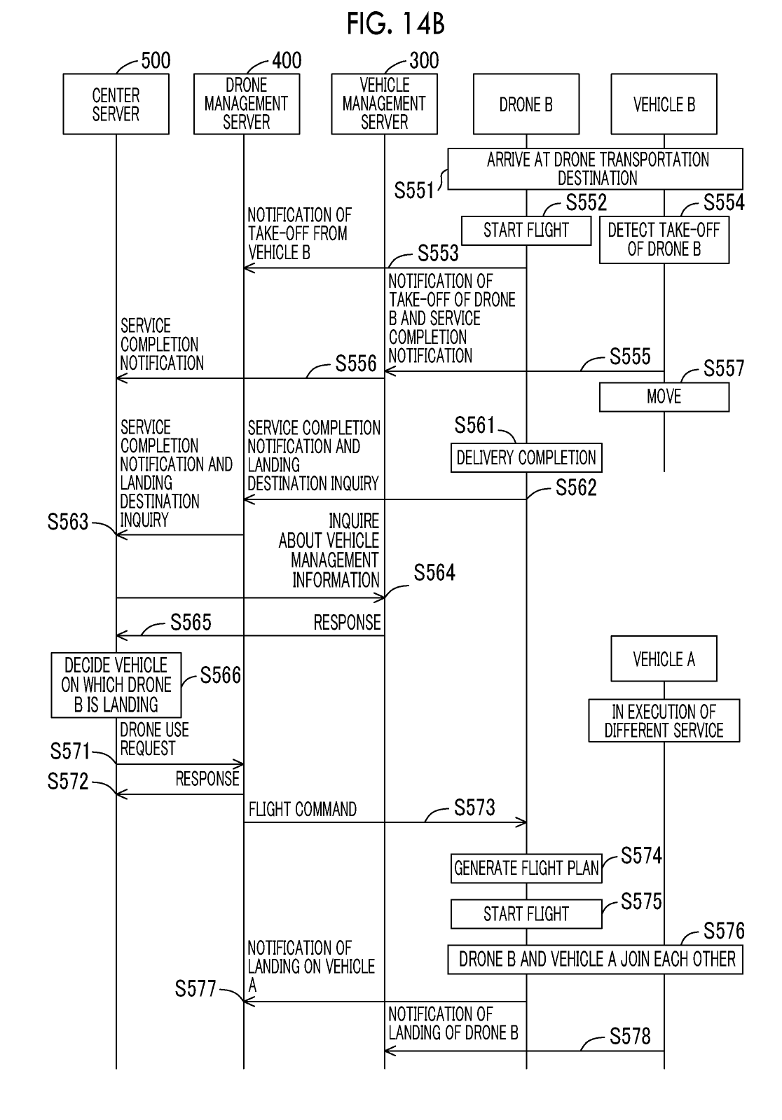

FIGS. 14A and 14B are diagrams showing an example of a processing sequence in Specific Example 2. Specific Example 2 is an example of a case where a request for a delivery service of a package is received. In Specific Example 2, an example where a vehicle B where any drone 200 does not land is selected as the delivery vehicle, and a drone B that does not land on any vehicle 100 is selected as the delivery drone will be described. In Specific Example 2, an example where the drone B returns to the vehicle A different from the vehicle B as the delivery vehicle when the drone B completes delivery will be described. As a premise of FIG. 14A, the drone B does not land on any vehicle 100. Any drone 200 does not land on the vehicle B. It is assumed that the drone B is in the service state of “IN NON-SERVICE”, it is assumed that the vehicle B is in the service state of “IN NON-EXCLUSIVE SERVICE”.

The processing of S511 to S515 is the same as the processing of S11 to S15 of FIG. 13A. That is, the center server 500 receives a request for a delivery service of a package with the drone 200 (S511), acquires the drone management information table from the drone management server 400 (S512, S513), and acquires the vehicle management information table from the vehicle management server 300 (S514, S515). It is assumed that information relating to the service is the same as in Specific Example 1.

In S516, the center server 500 selects the vehicle B as the delivery vehicle and selects the drone B as the delivery drone. It is assumed that the vehicle B is within the second range from the collection and delivery center as the first via-point and closest to the collection and delivery center (FIG. 11, S203: YES, S205), and the drone B is within the first range from the vehicle B and closest to the vehicle B (FIG. 11, S206: YES, S207).

The processing of S521 to S525 is the same as the processing of S21 to S25 of FIG. 13A. That is, the center server 500 transmits a vehicle use request of the vehicle B to the vehicle management server 300 and receives a response (S521, S522), the vehicle management server 300 transmits an operation command to the vehicle B (S523), and the vehicle B generates an operation plan (S524) and starts an operation to the collection and delivery center A (S525). The contents of the operation command transmitted in S523 and the operation plan generated in S524 are the same as the contents of the operation command transmitted in S23 of FIG. 13A and the operation plan generated in the S24, respectively. With the reception of the response in S522, in Specific Example 2, the drone transportation destination is decided to a point closest to a destination on a route of a different service of the vehicle B as the delivery vehicle.

The processing of S531 to S534 is the same as the processing of S31 to S34 of FIG. 13A. That is, the center server 500 transmits a drone use request of the drone B to the drone management server 400 and receives a response (S531, S532), the drone management server 400 transmits, a flight command to the drone B (S533), and the vehicle B generates a flight plan (S534).

As information relating to the service to be transmitted along with the drone use request in S531, for example, the vehicle B as the delivery vehicle, the positional information of the collection and delivery center A as the first via-point, positional in formation of a point on the route of the vehicle B closest to the delivery destination as the drone transportation destination, the positional information of the delivery destination as the destination, the identification information of the delivery package, and the like are also transmitted. The flight command transmitted to the drone B in S533 includes, for example, information relating to the service, a command for landing on the vehicle B, a command for take-off at the drone transportation destination, a command for transportation of the package to the destination, and the like. The flight plan generated by the drone B in S534 includes, for example, landing on the vehicle B, loading the package, taking off at the drone transportation destination (take-off point), a flight route to the delivery destination (destination), unloading the package at the delivery destination, and the like.

In S535, the drone B starts a flight toward the vehicle B according to the flight plan. In this case, since the drone B is within a range (first range) in which the BLE signal transmitted from the vehicle B is receivable, the drone B estimates the position of the vehicle B from the BLE signal of the vehicle B and performs a flight.

In S541, the drone B lands on the landing field of the vehicle B, and the drone B and the vehicle B join each other. In S542, the drone B transmits a notification of landing on the vehicle B to the drone management server 400. In 5543, the vehicle B transmits a notification of landing of the drone B to the vehicle management server 300. In S544, the vehicle B moves toward the collection and delivery center A (first via-point ), whereby the vehicle B and the drone B arrive at the collection and delivery center A, and the package is loaded on the drone B.

The processing of S551 to S556 of FIG. 14B is the same as the processing of S51 to S56 of FIG. 13B. That is, when the vehicle B arrives at the drone transportation destination (S551), the drone B starts a flight to the delivery destination (destination) (S552). The drone B transmits a notification of take-off from the vehicle B to the drone management server 400 (S553). The vehicle B detects take-off of the drone B (S554), and transmits a notification of take-off of the drone B to the vehicle management server 300 (S555). The vehicle B arrives at the drone transportation destination to detect service completion and transmits a service completion notification to the center server 500 through the vehicle management server 300 (S556).

In S557, for example, it is assumed that the vehicle B is away from the drone B since the vehicle B is executing a different non-exclusive service and is moving on a route to a destination of the different non-exclusive service.

The processing of S561 to S565 is the same as the processing of S61 to S65 of FIG. 13B. That is, when delivery of the package is completed (S561), the drone B transmits the service completion notification and the inquiry of the landing destination to the center server 500 through the drone management server 400 (S562, S563). When the inquiry of the landing destination of the drone B is received, the center server 500 acquires the vehicle management information table from the vehicle management server 300 (S564, S565).

In S566, the center server 500 decides, as the landing destination of the drone B, the vehicle A that is in the vicinity of the drone B and is executing the different service an where any drone 200 does not land (FIG. 12, S304: YES).

In S571, the center server 500 transmits a drone use request on the drone B to the drone management server 400 (FIG. 12, S305). As information relating to the service to be transmitted along with the drone use request in 5571, for example, the positional information of the vehicle A as the delivery vehicle, a via-point of the service that the vehicle A is executing, the drone transportation destination, and, the destination, and the like are transmitted.

In S572, the drone management server 400 transmits a response to the center server 500. In S573, the drone management server 400 transmits a flight command, including a command for landing on the vehicle A to the drone B as a response to the inquiry of the landing destination. The flight command transmitted to the drone B in S573 includes, for example, information relating to the service that the vehicle A is executing, the command for landing on the vehicle A, a command for take-off at the drone transportation destination, and the like.

The processing of subsequent S574 to S578 is the same as the processing of S73 to S77 of FIG. 13B. That is, the drone B generates a flight plan to the vehicle A (S574), and starts a flight toward the vehicle A (S575). When the drone B lands on the landing field of the vehicle A and joins the vehicle A (S576), the drone B transmits a notification of landing on the vehicle A to the drone management server 400 (S577), and the vehicle A transmits a notification of landing on the drone B to the vehicle management server 300 (S578).

In S578, since the vehicle management server 300 receives a vehicle monitoring request on the vehicle A, the notification of landing of the drone B transmitted from the vehicle A to the vehicle management server 300 is transmitted to the center server 500. When the notification of landing on the drone B from the vehicle A is received (FIG. 10B, S122), the center server 500 transmits a drone use request on the drone B to the drone management server 400 (FIG. 10B, S123). When a response is received from the drone management server 400 (FIG. 10B, S124), the center server 500 confirms the drone B as the delivery drone of the service that the vehicle A is executing, and subsequently, the drone B operates as the delivery drone of the service that the vehicle A is executing. With this, in the service that the vehicle A is executing, the timing when the delivery drone is decided is made earlier, and it is possible to reduce a waiting time in the service that the vehicle A is executing.

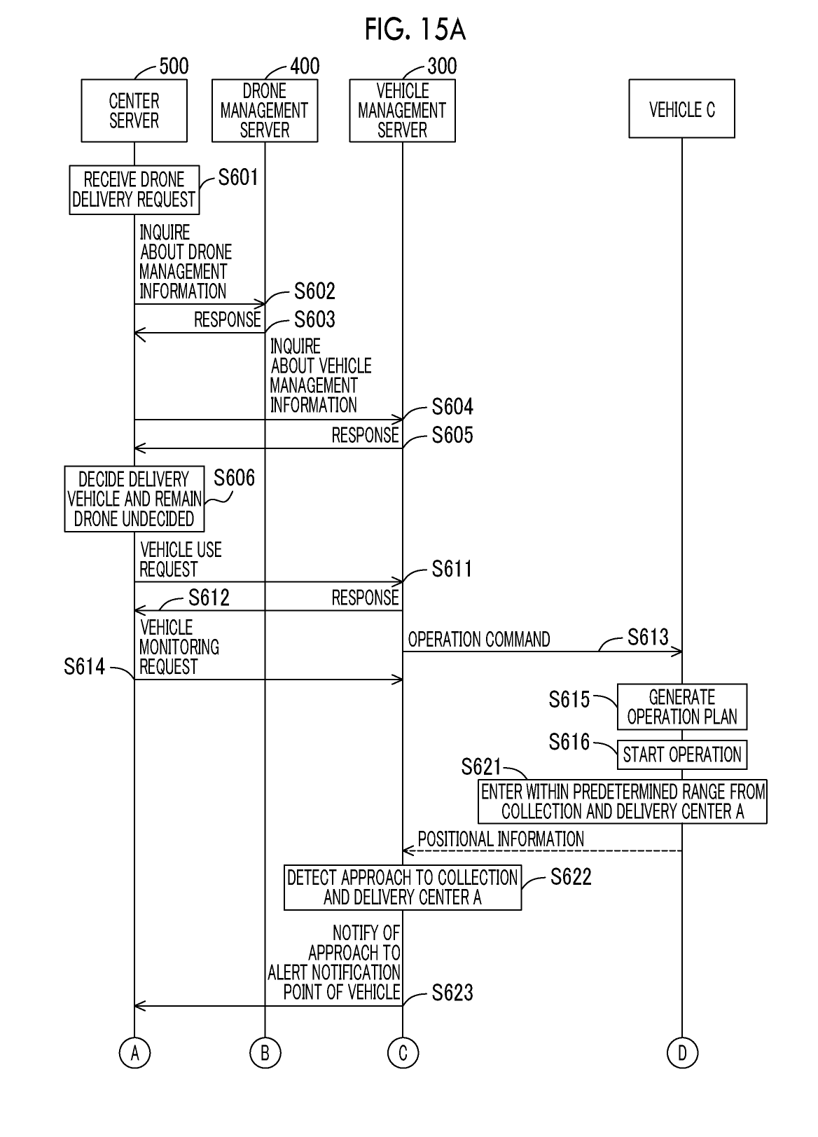

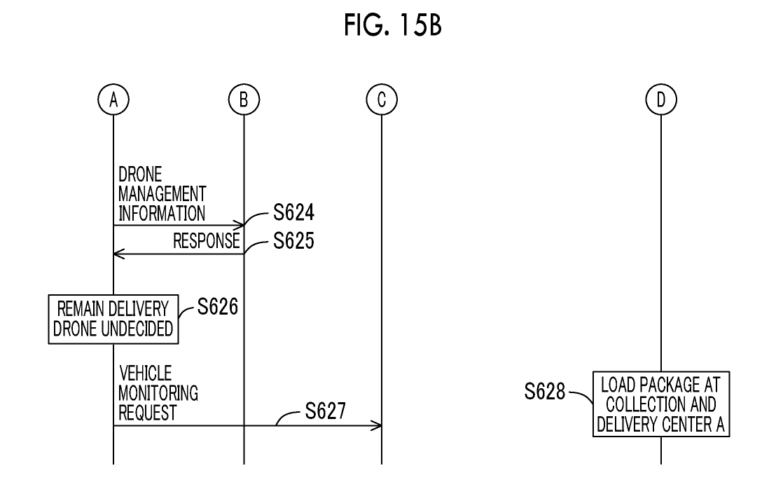

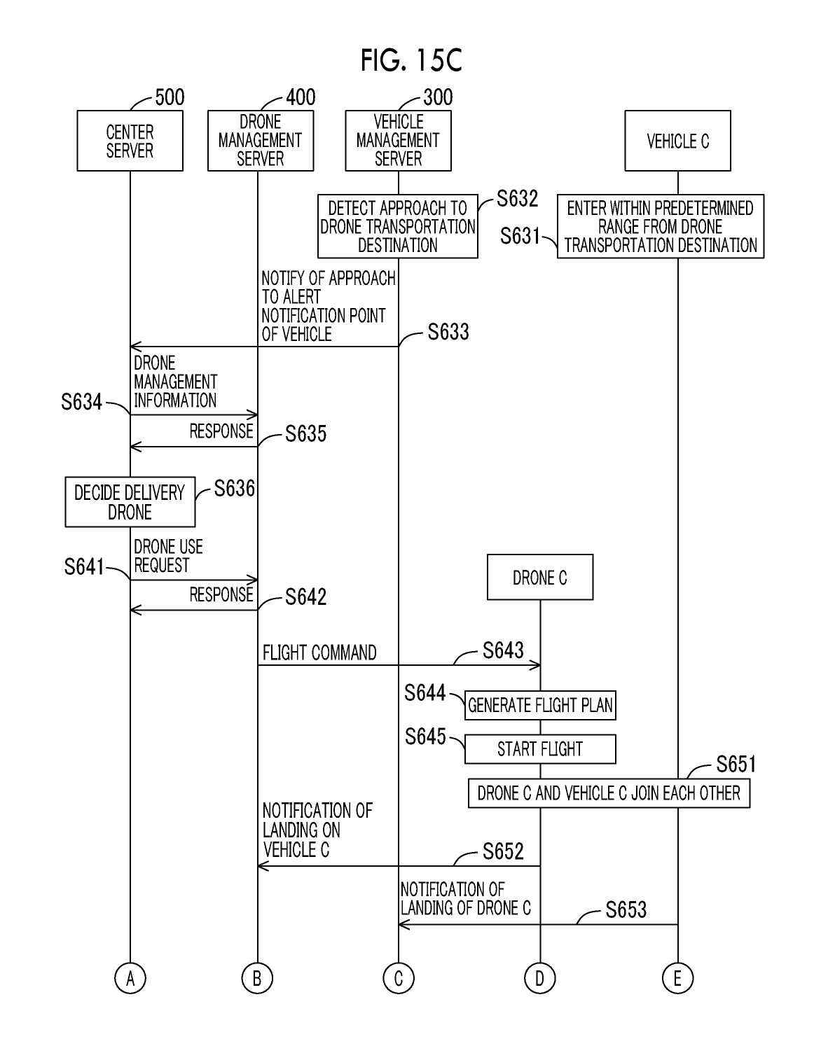

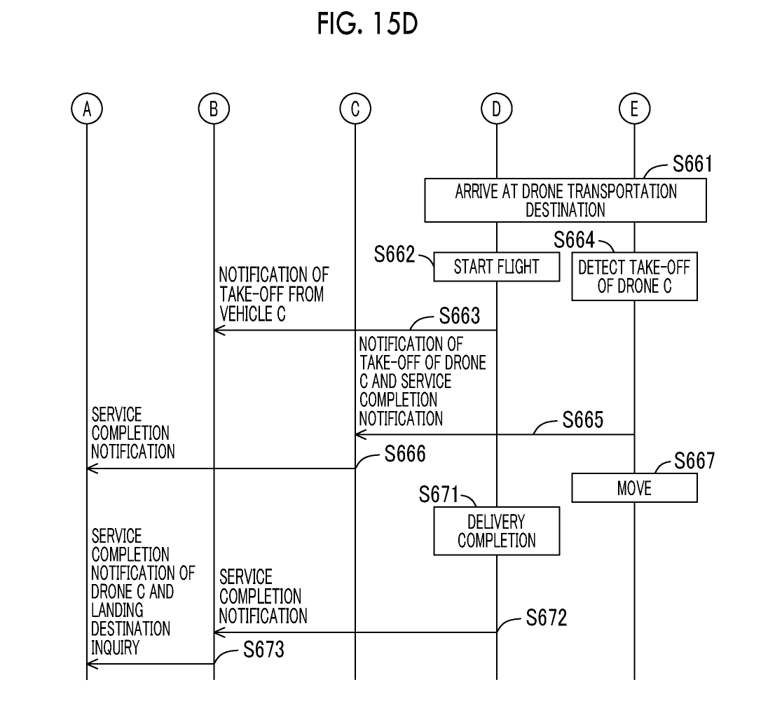

FIGS. 15A to 15D are diagrams showing an example of a processing sequence in Specific Example 3. Specific Example 3 is an example of a case where a request for a delivery service of a package is received. In Specific Example 3, an example where a sole vehicle C is selected as the delivery vehicle, cannot join the drone 200 before the collection and delivery center A (first via-point), and joins the drone 200 at the drone transportation destination will be described. As a premise of FIGS. 15A and 15B, any drone 200 does not land on the vehicle C. It is assumed that the vehicle C is in the service state of “IN NON-SERVICE”.

The processing of S601 to S605 is the same as the processing of S11 to S15 of FIG. 13A. That is, the center server 500 receives a request for a delivery service of a package with the drone 200 (S601), acquires the drone management information table from the drone management server 400 (S602, S603), and acquires the vehicle management information table from the vehicle management server 300 (S604, S605). It is assumed that information relating to the service is the same as in Specific Example 1.

In S606, since there is no the vehicle 100 where the drone 200 lands within the second range from the collection and delivery center A as the first via-point, and the vehicle C is closest to the drone 200 within the second range (FIG. 11, S203: YES), the center server 500 decides the delivery vehicle to the vehicle C. In Specific Example 3, determination is made that the drone 200 is not within the first range from the vehicle C, and for this reason (FIG. 11, S206: NO), the center server 500 remains the delivery drone undecided (FIG. 11, S208).

In S611, the center server 500 transmits a vehicle use request on the vehicle C to the vehicle management server 300 (FIG. 10A, S106). In S612, the vehicle management server 300 transmits a response to the center server 500 (FIG. 10A, S107: YES). With this, the center server 500 sets the drone transportation destination to the vehicle reachable limit point closest to the delivery destination of the package (FIG. 10A, S108). In S613, the vehicle management server 300 transmits an operation command to the vehicle C. The operation command transmitted to the vehicle C in S613 is the same as the operation command transmitted to the vehicle A in S23 of FIG. 13A.

In S614, the center server 500 transmits a vehicle monitoring request on the vehicle C to the vehicle management server 300 (FIG. 10A, S109: YES, FIG. 10B, S121). An alert notification point of the vehicle monitoring request in S614 is the collection and delivery center A as the first via-point (FIG. 11, S206: NO, S208).

In S615, the vehicle C generates an operation plan based on the operation command from the vehicle management server 300. In S616, the vehicle C starts an operation according to the operation plan, and first moves toward the collection and delivery center A.

In S621, the vehicle C enters within a predetermined range from the collection and delivery center A (alert notification point). In S622, the vehicle management server 300 detects that the vehicle C enters within the predetermined range from the collection and delivery center A (alert notification point), that is, the vehicle C is, approaching the collection and delivery center A from positional information of the vehicle C to be transmitted from the vehicle C in a predetermined cycle. In S623, the vehicle management server 300 transmits, to the center server 500, an alert for notifying of the approach of the vehicle C to the alert notification point.

In S624, the center server 500 receives the alert from the vehicle management server 300 (FIG. 10B, S125: YES), and inquires of the drone management server 400 about the drone management information table. In S625, the drone management server 400 transmits the drone management information table to the center server 500 as a response, and the center server 500 receives the drone management information table (FIG. 10B, S126).

In S626, since there is no drone within the first range from the vehicle C (FIG. 10C, S128: NO), and there is no via-point subsequent to a second via-point in the service (FIG. 10C, S132: NO), the center server 500 sets the delivery drone to be undecided (FIG. 10C, S135). Furthermore, the center server 500 sets the alert notification point to the drone transportation destination.

In S627, the center server 500 transmits the vehicle monitoring request on the vehicle C to the vehicle management server 300 (FIG. 10B, S121). The alert notification point of the vehicle monitoring request in S627 is the drone transportation destination (the vehicle reachable limit point closest to the delivery destination). In S628, the vehicle C arrives at the collection and delivery center A and loads the delivery package.

In S631 of FIG. 15C, the vehicle C enters within a predetermined range from the drone transportation destination (alert notification point). In S632, the vehicle management server 300 detects, from the positional information of the vehicle C, that the vehicle C is approaching the drone transportation destination (alert notification point). In S633, the vehicle management server 300 transmits, to the center server 500, an alert for notifying of the approach of the vehicle C to the alert notification point.

In S634, the center server 500 receives the alert from the vehicle management server 300 (FIG. 10B, S125: YES), and inquires of the drone management server 400 about the drone management information table. In S635, the drone management server 400 transmits the drone management information table to the center server 500 as a response, and the center server 500 receives the drone management information table (FIG. 10B, S126).

In S636, the center server 500 detects that there is a drone C within the first range from the vehicle C (FIG. 10C, S128: YES), and selects the drone C as the delivery drone (FIG. 10C, S129).

The processing of S641 to S645 is the same as the processing of S531 to S535 of FIG. 14A. That is, the center server 500 transmits a drone use request on the drone C to the drone management server 400 and receives a response (S641, S642), the drone management server 400 transmits a Eight command to the drone C (S643), and the vehicle C generates a flight plan (S644).

As information relating to the service to be transmitted along with the drone use request in S641, for example, landing on the vehicle C as the delivery vehicle, positional information of the vehicle reachable limit point to the delivery destination as the drone transportation destination, positional information of the delivery destination as the destination, the identification information of the delivery package, and the like are also transmitted. The flight command transmitted to the drone C in S643 includes, for example, information relating to the service, a command for landing on the vehicle C, a command for take-off at the drone transportation destination, a command for transportation of the package to the destination, and the like. In the flight plan generated by the drone C in S644 includes, for example, landing on the vehicle C, loading the package, taking off at the drone transportation destination (take-off point), a flight route to the delivery destination (destination), unloading the package at the delivery destination, and the like.

In S645, the drone C starts a flight toward the vehicle C according to the flight plan. In this ease, since the drone C is within a range (first range) in, which the BLE signal transmitted from the vehicle C is receivable, the drone C estimates the position of the vehicle C from the BLE signal of the vehicle C and performs a flight.

In S651, the drone C lands on the landing field of the vehicle C, and the drone C and the vehicle C join each other. The delivery package is loaded in the vehicle C, and the drone C lands on the landing field of the vehicle C and loads the delivery package. In S652, the drone C transmits a notification of landing on the vehicle C to the drone management server 400. In S653, the vehicle C transmits a notification of landing of the drone C to the vehicle management server 300.

The processing of S661 to S667 is the same as the processing of S551 to S557 of FIG. 14B. That is, when the vehicle C arrives at the drone transportation destination (S661), the drone C starts a flight to the delivery destination (destination) (S662). The drone C transmits a notification of take-off from the vehicle C to the drone management server 400 (S663). The vehicle C detects take-off of the drone C (S664), and transmits a notification take-off of the drone C to the vehicle management server 300 (S665). The vehicle C detects service completion when arriving at the drone transportation destination and transmits a service completion notification to the center server 500 through the vehicle management server 300 (S666). It is assumed that the vehicle C moves and is away from the drone C (S667).

In S671, the drone C completes delivery of the package. In S672, the drone C transmits a service completion notification and an inquiry of the landing destination to the drone management server 400. In S673, the drone management server 400 transmits the service completion notification and the inquiry of the landing destination of the drone C to the center server 500.

Subsequently, for example, as after 564 of FIG. 13B or after S564 of FIG. 14B, the landing destination of the drone C is decided by the center server 500, and the drone C moves to and lands on the vehicle 100 as the decided landing destination.

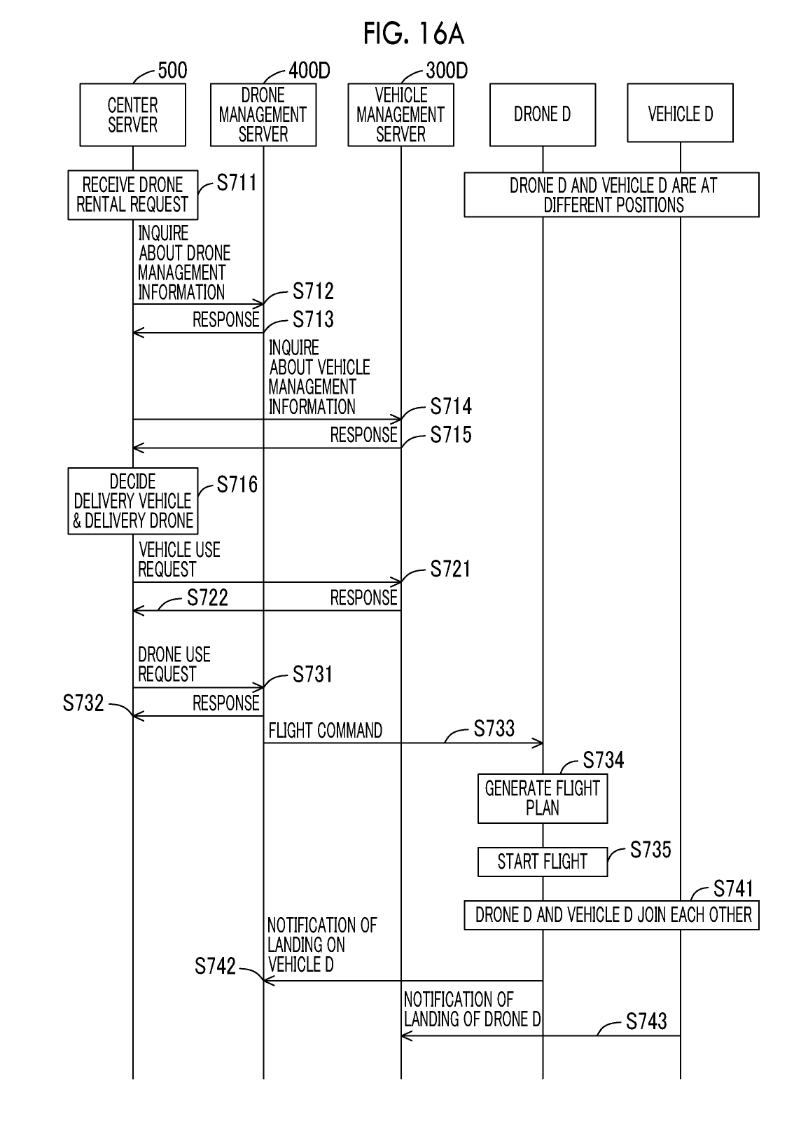

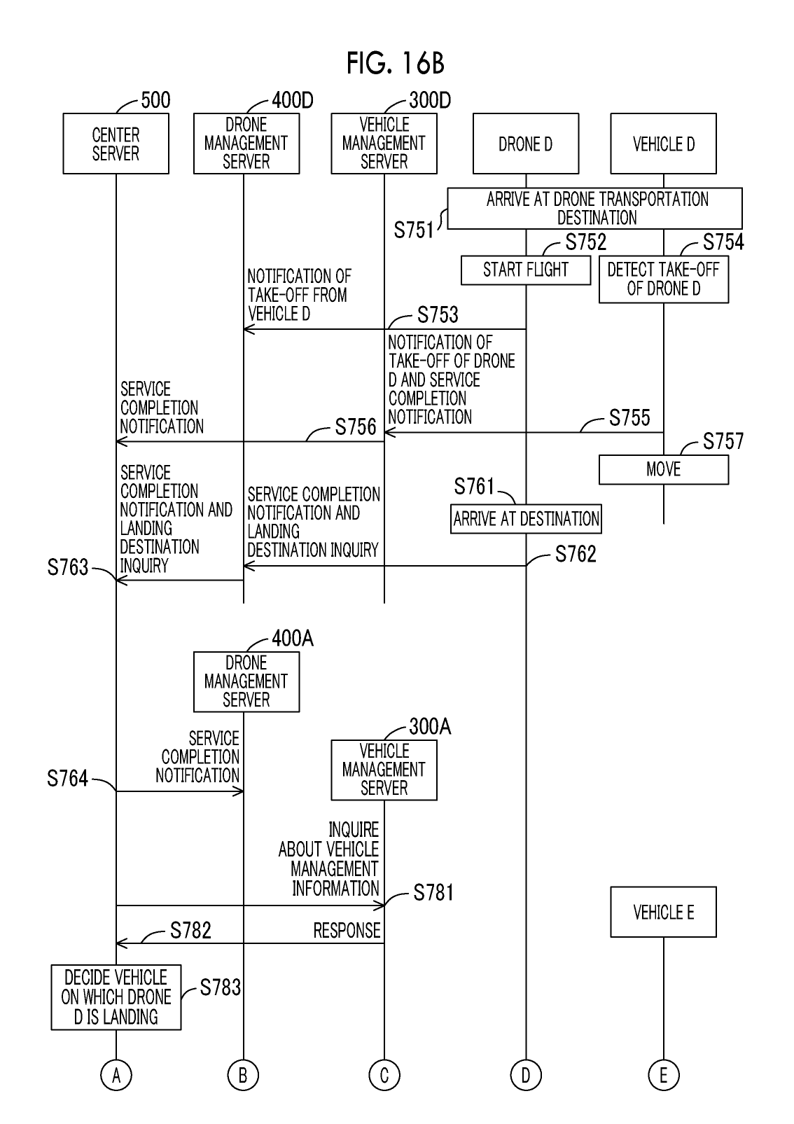

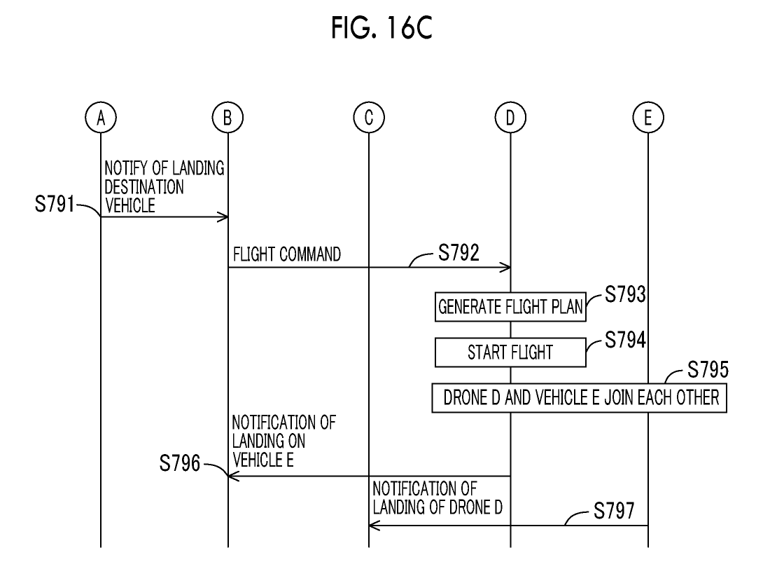

FIGS. 16A to 16C are diagrams showing an example of a processing sequence in Specific Example 4. Specific Example 4 is an example of a case where a request for a rental service of the drone 200 is received. In Specific Example 4, for example, it is assumed that the vehicle management server 300 and the drone management server 400 are in each prescribed area, and the vehicle 100 and the drone 200 are managed for each area. Subsequently, for example, it is assumed that a server managing an area A is represented by attaching the same alphabet A as the area to the tail of reference numeral.

In S711, the center server 500 receives a drone rental request. In Specific Example 4, it is assumed that, since the drone 200 falls short in the area A, a request for a rental service of a drone occurs from a drone management server 400A of the area A to the center server 500. In the request for the rental service of the drone 200 in Specific Example 4, for example, positional information of a predetermined point in the area A is also received as a rental destination of the drone 200. Accordingly, in Specific Example 4, no via-point is set in the service, and the destination becomes the predetermined point in the area A.

In S712, the center server 500 decides to rent the drone 200 from an area D as an adjacent area of the area A and inquires of a drone management server 400D of the area D about a drone management information table. In S713, the drone management server 400D transmits the drone management in information table of the area D to the center server 500. In S714, a vehicle management information table is inquired of a vehicle management server 300D of the area D. In S715, the vehicle management server 300D transmits the vehicle management information table of the area D to the center server 500.

In S716, the center server 500 decides a vehicle D as the delivery vehicle and decides a drone D as the delivery drone. This is because, in Specific Example 4, there is no vehicle 100, on which the drone lands, in the area D (FIG. 11, S201: NO), and the vehicle 100 closest to the predetermined point in the area A among the vehicles 100 toward the predetermined point in the area A as the destination is the vehicle D (FIG. 11, S205). It is assumed that the vehicle D is in the service state of “IN NON-EXCLUSIVE SERVICE”. The reason that the drone D is selected as the delivery drone is because the drone D is within the first range from the vehicle D and is closest to the vehicle D (FIG. 11, S206: YES, S207).

In S721, the center server 500 transmits a vehicle use request on the vehicle D to the vehicle management server 300D (FIG. 10A, S106). In S722, the vehicle management server 300D transmits a response to the center server 500 (FIG. 10A, S107: YES). With this, the center server 500 decides the drone transportation destination to a point on a route of the vehicle D closest to the predetermined point in the area A (FIG. 10A, S105). In Specific Example 4, since the route of the vehicle D is not changed, an operation command is not transmitted from the vehicle management server 300D to the vehicle D.

In S731, the center server 500 transmits a drone use request on the drone D to the drone management server 400D (FIG. 10A, S110). In S732, the drone management server 400D transmits a response to the center server 500, and the center server 500 receives the response (FIG. 10A, S111: YES). In S733, the drone management server 400D transmits a flight command to the drone D. As information relating to the service to be transmitted along with the drone use request in S731, for example, the vehicle D of the delivery vehicle, positional information of the point on the route of the vehicle D closest to the predetermined point in the area A as the drone transportation destination, positional information of the predetermined point as the rental destination in the area A as the destination, and the like are also transmitted. The flight command transmitted to the drone D in S733 includes, for example, information relating to the service, a command for landing on the vehicle D, a command for take-off at the drone transportation destination, a flight command to the destination, and the like are included.

In S734, the drone D generates a flight plan based on the flight command from the drone management server 400D. The flight plan generated by the drone D in S734 includes, for example, landing on the vehicle D, taking off at the drone transportation destination (take-off point), a flight route to the rental destination (destination), and the like.

In S735, the drone D starts a flight toward the vehicle D according to the flight plan. In this case, since the drone D is within a range (first range) in which the BLE signal transmitted front the vehicle D is receivable, the drone D estimates the position of the vehicle D from the BLE signal of the vehicle D and performs a flight.

In S741, the drone D lands on the landing field of the vehicle D, and the drone D and the vehicle D join each other. In S742, the drone D transmits a notification of landing on the vehicle D to the drone management server 400D. In S743, the vehicle D transmits a notification of landing of the drone D to the vehicle management server 300D.

The processing of S751 to S757 of FIG. 16B is the same as the processing of S551 to S557 of FIG. 14B. That is, when the vehicle D where the drone D lands arrives at the drone transportation destination (S751), the drone D starts a flight to the rental destination (destination) (S752). The drone D transmits a notification of take-off from the vehicle D to the drone management server 400D (S753). The vehicle D detects take-off of the drone D (S754), and transmits a notification of take-off of the drone D to the vehicle management server 300D (S755). The vehicle D detects service completion when arriving at the drone transportation destination and transmits a service completion notification to the center server 500 through the vehicle management server 300D (S756). The vehicle D is executing a different non-exclusive service, moves on a route of the different non-exclusive service, and is away from the drone D (S757).

The processing of S761 to S763 is the same as the processing of S561 to S563 of FIG. 14B. That is, when arriving at the rental destination (destination) (S761), the drone D transmits a service completion notification and an inquiry of the landing destination to the center server 500 through the drone management server 400D (S762, S763).

In S764, since the service completion notifications are received from the vehicle D as the delivery vehicle and the drone D as the delivery drone, the center server 500 transmit the service completion notification to the drone management server 400A of the area A as a request source for the service. Identification information of the drone D moving to the area A is notified to the drone management server 400A along with the service completion notification. Though not shown, the center server 500 notifies the drone D of information of the drone management server 400A of the area A through the drone management server 400D. With this, the drone D transmits the positional information to the drone management server 400A, thereby receiving a flight command from the drone management server 400A.

In S781, the center server 500 receives the service completion notification and the inquiry of the landing destination from the drone D (FIG. 12, S301: YES), and since there is no service having the destination in the vicinity of the drone D and there is no vehicle 100 before service that needs the drone D (FIG. 12, S302: NO, S304: NO), inquires of the vehicle management server 300A about a vehicle management information table (FIG. 12, S306). The reason that the vehicle management information table is inquired of the vehicle management server 300A in S781 is because the current position of the drone D received along with the inquiry of the landing destination is in the area A. In S782, the vehicle management server 300A transmits the vehicle management information table of the area A to the center server 500 as a response.

In S783, the center server 500 selects a vehicle E as the vehicle 100 closest to the drone D based on the positional information of the drone D and the positional information of each vehicle 100 included in the vehicle management information table of the area A (FIG. 12, S307).

The processing of subsequent S791 to S797 is the same as the processing of S71 to S77 of FIG. 13B. That is, the center server 500 notifies the drone management server 400A of the vehicle F as the landing destination as a response to the inquiry of the landing destination of the drone D (S791), and the drone management server 400A transmits a flight command including a command for landing on the vehicle E to the drone D (S792). The drone D generates a flight plan to the vehicle E (S793), and starts a flight (S794). When the drone D lands on the landing field of the vehicle E and joins the vehicle E (S795), the drone D transmits a notification of landing on the vehicle E to the drone management server 400A (S796), and the vehicle E transmits a notification of landing of the drone D to the vehicle management server 300A (S797).

When the use of the drone D in the area A ends, a return request of the drone D is transmitted from the drone management server 400A of the area A to the center server 500, and as in FIGS. 16A to 16C, the drone D is returned to the area in the same manner as the rental request.

### Functional Effects of First Embodiment

According to the first embodiment, the delivery drone and the delivery vehicle are selected based on the destination or the via-point and the positional relationship between the drone 200 and the vehicle 100. For example, in the first embodiment, the vehicle 100 where the drone 200 lands and the drone 200 within the second range from the destination or the via-point are selected with priority as the delivery vehicle and the delivery drone. In the first embodiment, when there is not vehicle 100, on which the drone 200 lands, within the second range from the destination or the via-point a sole vehicle within the second range from the destination or the via-point is selected as the delivery vehicle and the drone 200 within the first range from the sole vehicle is selected as the delivery drone. In the first embodiment, while a sole vehicle is selected as the delivery vehicle when a request for a service is received, when there is no drone close to the delivery vehicle, the drone remains unselected, and when the delivery vehicle approaches the destination or the via-point, the drone 200 in the vicinity is searched, and the delivery drone is selected.

With this, for example, since it is possible to reduce the time for which the delivery vehicle or the delivery drone waits for the delivery drone or the delivery vehicle, it is possible to make the delivery vehicle or the delivery drone go toward the destination or the via-point earlier. Furthermore, since it is possible to further reduce the flight distance of the delivery drone, it is possible to save electric power of the drone, and to perform a service using a drone for a longer time. With this, it is possible to improve overall efficiency of a service using a drone.

In the first embodiment, since take-off and landing of the drone 200 is not limited to the landing field of one vehicle 100, the drone 200 can land on the vehicle 100 different from the vehicle 100 where the drone 200 takes off. With this, the degree of freedom of take-off and landing of the drone 200 is improved, and it is possible to improve overall efficiency of a service using a drone. For example, when the drone 200 is allowed to land on the closest vehicle 100, it is possible to save the flight distance of the drone 200.

In the first embodiment, even though the vehicle 100 is executing a different service, the vehicle 100 can be selected as the landing destination of the drone 200. A drone transportation destination of a service that the drone 200 is executing is set to a vehicle reachable limit point closest to the destination when the vehicle 100 is in non-service, and is set to a point on the route of the vehicle 100 closest to the destination when the vehicle 100 is in service. With this, it is possible to improve use efficiency of the vehicle 100.

In the first embodiment, a sole vehicle that is executing a service is selected with priority as a landing place of the drone 200 that completes a service, and the drone 200 operates as the delivery drone of the service that the sole vehicle is executing (FIG. 12, S305 and the like). With this, it is possible to improve use efficiency of the drone 200.

In the first embodiment, when a destination of a different service is in the vicinity of the drone 200 that completes a service, the drone 200 is made to go toward the destination (FIG. 12, S303 and the like). The different service is, for example, a rental service of a drone. With this, it is possible to reduce a waiting time until the drone arrives at the destination of the different service.

In the first embodiment, since the vehicle 100 is an autonomous traveling vehicle, it is possible to save human resource, such as a driver. In the first embodiment, since the vehicle 100 is provided with a power feed facility of the drone 200, the drone 200 can be charged while landing on the vehicle 100, and it is possible to use the drone 200 for a longer time. It is also possible to restrain service stop due to shortage of electric power of the drone 200.

Others

In the first embodiment, although description has been provided as a premise that the center server 500 is an independent device, the center server 500 may be constituted on the same device as any one of the vehicle management server 300 and the drone management server 400, for example. Alternatively, all of the center server 500, the vehicle management server 300, and the drone management server 400 may be constituted on a single device.

In the first embodiment, although, in regards to the delivery vehicle and the delivery drone, the delivery vehicle is first decided, and then, the delivery drone is decided based on the delivery vehicle, the disclosure is not limited thereto. The delivery drone may be first decided, and then, the delivery vehicle may be decided based on the delivery drone. Specifically, for example, the drone 200 closest to the first via-point or the destination may be decided as the delivery drone, and the vehicle 100 closest to the delivery drone may be decided as the delivery vehicle.

In the first embodiment, although, when arrival at the drone transportation destination is detected, the delivery drone takes off from the delivery vehicle, a timing for take-off of the delivery drone from the delivery vehicle is not limited thereto, and the delivery drone may take off from the delivery vehicle, for example, when detection is made that a distance from the destination is equal to or less than a predetermined distance.

In the first embodiment, although the single vehicle 100 operates as the delivery vehicle from service start until service completion, the disclosure is not limited thereto, and the vehicle that operates as the delivery vehicle may be changed according to the progress of the service. For example, in delivery of a package, the vehicle 100 that goes toward the pick-up place as the via-point may be different from the vehicle 100 that goes toward the destination. Specifically, for example, the delivery drone may land on a vehicle X, the vehicle X may arrive at the pick-up place, the delivery drone may load the package, and the delivery drone may be transferred to a vehicle Y that is in the vicinity of the delivery drone and goes toward the delivery destination. For example, the center server 500 performs processing for monitoring the progress of the service and selecting the vehicle 100 suitable as the delivery vehicle each time the delivery drone arrives at each via-point.

In the first embodiment, although the center server 500 selects the delivery vehicle and the delivery drone, the disclosure is not limited thereto, and for example, the center server 500 may select the delivery vehicle or the delivery drone, and the delivery vehicle or the delivery drone itself may select the delivery drone or the delivery vehicle. Alternatively, when the vehicle 100 and the drone 200 are communicable directly without passing through the various servers, the vehicle 100 and the drone 200 may receive a request for a service, and decide the delivery vehicle and the delivery drone, and execute the service, respectively.

Recording Medium

A program that causes a computer or other machines or apparatuses (hereinafter, referred to as a computer or the like) to implement the above-described issuance control can be recorded in a recording medium that is readable by the computer or the like. The computer functions as the above-described center server 500 by causing the computer or the like to read and execute the program of the recording medium.

Here, the recording medium that is readable by the computer or the like refers to a non-transitory recording medium that stores information such as data or programs by electric, magnetic, optical, mechanical, or chemical actions and is readable by the computer or the like. Among such recording mediums, examples of a recording medium detachable from a computer or the like may include a flexible disk, a magneto-optical disk, a CD-ROM, a CD-R/W, a digital versatile disc (DVD), a Blu-ray disk, a digital audio tape (DAT), an 8 mm tape, a memory card such as a flash memory, and the like. Furthermore, examples of a recording medium fixed to the computer or the like may include a hard disk, a read only memory (ROM), and the like. In addition, a solid state drive (SSD) may be used as either a recording medium that is detachable from the computer or the like or a recording medium that is fixed to the computer or the like.

What is claimed is:

1. A drone management system comprising:
a plurality of drones configured to fly;
a plurality of vehicles each provided with a landing field where at least one of the drones is able to take off and land;
a reception unit configured to receive a request for a service using a drone;
an acquisition unit configured to acquire positional relationships between the drones and the vehicles; and
a controller configured to
select a first drone that flies to a destination of the service from among the drones; and
select a first vehicle as a landing destination of the first drone from among the vehicles based on the positional relationships between the drones and the vehicles,
wherein the firs t vehicle and the first drone are configured to provide the service based on the selection.

2. The drone management system according to claim 1, wherein the first drone is configured to start flight to the destination of the service when the first vehicle has reached a predetermined point.

3. The drone management system according to claim 2, wherein the controller is configured to
i) set a reachable point of the first vehicle within a predetermined range from the destination of the service as the predetermined point when the first vehicle is not executing a different service, and
ii) set a point on a route of the first vehicle within the predetermined range from the destination of the service as the predetermined point when the first vehicle is executing a different service.

4. The drone management system according to claim 2, wherein the controller is configured to, when there is a vehicle where at least one drone lands on the landing field, perform both of
i) selecting, as the first vehicle, the vehicle where at least one drone lands on the landing field, and
ii) selecting the first drone from among the at least one drone that lands on the vehicle selected as the first vehicle.

5. The drone management system according to claim 4, wherein the controller is configured to perform, when there is no vehicle where at least one drone lands on the landing field within a first range from a first via-point or the destination in the service, the first via-point being a via-point that the first vehicle or the first drone stops by for the first time, any one of
i) selecting, as the first vehicle, a vehicle where any drone within the first range from the first via-point or the destination does not land and selecting, as the first drone, a drone that does not land on any vehicle within a second range from the vehicle selected as the first vehicle, and
ii) selecting, as the first drone, a drone that does not land on any vehicle within the first range from the first via-point or the destination and selecting, as the first vehicle, a vehicle where any drone within the second range from the drone selected as the first drone does not land.

6. The drone management system according to claim 4, wherein the controller is configured to
i) select, when there is no vehicle where at least one drone lands on the landing field within a first range from a first via-point that the first vehicle or the first drone stops by for the first time in the service, the first vehicle from among vehicles where any drone within the first range from the first via-point does not land,
ii) set, when there is no drone within a second range from the vehicle selected as the first vehicle, the first drone to be unselected, and
iii) select, when detection is made that the first vehicle enters within a predetermined range from any one of the first via-point, a via-point subsequent to the first via-point, and the destination, the first drone from among drones within the second range from a current position of the first vehicle.

7. The drone management system according to claim 1, wherein the controller is configured to select a second vehicle to be a landing place of the first drone from among vehicles within a predetermined range from a current position of the first drone when predetermined processing of the service at the destination with the first drone ends.

8. The drone management system according to claim 7, wherein the controller is configured to select the second vehicle from among, vehicles where any drone does not land within the predetermined range from the current position of the first drone.

9. The drone management system according to claim 7, wherein the controller is configured to decide, when there is a destination of a different service within the predetermined range from the current position of the first drone, flight of the first drone to the destination of the different service.

10. The drone management system according to claim 1, wherein each of the vehicles is a vehicle that is able to autonomously travel.

11. The drone management system according to claim 1, wherein:
each of the drones is provided with a secondary battery as a power supply; and
each of the vehicles is provided with a power feed facility that performs power feed to the secondary battery of the drone.

12. A drone management method comprising:
causing a management device to receive a request for a service using a drone, the management device being configured to manage a plurality of drones configured to fly and a plurality of vehicles each provided with a landing field where at least one of the drones is able to take off and land;
causing the management device to acquire positional relationships between the drones and the vehicles;
causing the management device to select a first drone that flies to a destination of the service from among the drones and select a first vehicle as a landing destination of the first drone from among the vehicles based on the positional relationships between the drones and the vehicles; and
causing the first vehicle and the first drone to provide the service based on the selection.
